(19) United States
(12) Patent Application Publication
(10) Pub. No.: US 2016/0077222 A1
(43) Pub. Date: Mar. 17, 2016

(54) NEW SINGLE CRYSTAL DIAMOND DOSIMETER AND USE THEREOF

(71) Applicant: COMMISSARIAT A L'ENERGIE ATOMIQUE ET AUX ENERGIES ALTERNATIVES, Paris (FR)

(72) Inventors: Fanny MARSOLAT, VILLEJUIF (FR); Nicolas TRANCHANT, VIRY-CHATILLON (FR); Dominique TROMSON, GIF-SUR-YVETTE (FR); Michal POMORSKI, MASSY-PALAISEAU (FR)

(21) Appl. No.: 14/786,022

(22) PCT Filed: Apr. 24, 2013
(86) PCT No.: PCT/IB2013/001153

§ 371 Date: Oct. 21, 2015

(51) Int. Cl. G01T 1/26; G01T 1/02

(52) U.S. Cl. CPC G01T 1/26; G01T 1/02

(57) ABSTRACT

The present invention relates to a new single crystal diamond dosimeter and use thereof.

The present invention relates to a new single crystal diamond dosimeter and use thereof.

Radiotherapy is one of the most powerful techniques used in cancer treatment. Very specific techniques with a specific clinical objective are now used to spare the healthy tissue while tumors are irradiated. The development of Stereotactic treatment has led to an increasing use of small X-ray beams, in the range of 3 to 40 mm in diameter. This advanced technique is used for the treatment of small tumors (less than 20 cm³), benign and malignant, intra and extra-cranial. In Stereotactic Radio surgery a relatively high dose is delivered in a single fraction (for instance, 90 Gy can be delivered to a patient with trigeminal neuralgia: D. Kondziolka, L. D. Lunsford, et J. C. Flickinger, [symbol] Gamma Knife Radiosurgery as the First Surgery for Trigeminal Neuralgia [symbol] , Stereotactic and Functional Neurosurgery, vol. 70, no. Suppl. 1, p. 187-191, 1998; D. Kondziolka, L. D. Lunsford, et J. C. Flickinger, [symbol] Stereotactic radiosurgery for the treatment of trigeminal neuralgia [symbol] , Clin J Pain, vol. 18, no. 1, p. 42-47, fevr. 2002.); in Stereotactic Radiotherapy multiple fractions of lower dose (1.8 Gy-4 Gy) are used (I. J. Das, M. B. Downes, A. Kassaee, et Z. Tochner, [symbol] Choice of Radiation Detector in Dosimetry of Stereotactic Radiosurgery-Radiotherapy [symbol] , Journal of Radiosurgery, vol. 3, no. 4, p. 177-186, 2000.).

Because of the complicated beam ballistic and realization, the stereotactic technique presents critical risks and requires a high accuracy in patient positioning and also in dose delivery. The accuracy in patient positioning is improved by the development of advanced imaging modalities and by fixing patient to stereotactic frame (F. Baba, Y. Shibamoto, N. Tomita, C. Ikeya-Hashizume, K. Oda, S. Ayakawa, H. Ogino, et C. Sugie, [symbol] Stereotactic body radiotherapy for stage I lung cancer and small lung metastasis: evaluation of an immobilization system for suppression of respiratory tumor movement and preliminary results [symbol] , Radiat Oncol, vol. 4, p. 15, 2009; J. Wulf, U. Hadinger, U. Oppitz, B. Olshausen, et M. Flentje, [symbol] Stereotactic radiotherapy of extracranial targets: CT-simulation and accuracy of treatment in the stereotactic body frame [symbol] , Radiother Oncol, vol. 57, no. 2, p. 225-236, November 2000.). Dosimetry of small beams is not accurately controlled, the main issue being the determination of Output Factors (OFs). Several authors compared different commercially available detectors and Monte Carlo simulations in small beams ((I. J. Das, M. B. Downes, A. Kassaee, et Z. Tochner, [symbol] Choice of Radiation Detector in Dosimetry of Stereotactic Radiosurgery-Radiotherapy [symbol] , Journal of Radiosurgery, vol. 3, no. 4, p. 177-186, 2000; A. J. D. Scott, A. E. Nahum, et J. D. Fenwick, [symbol] Using a Monte Carlo model to predict dosimetric properties of small radiotherapy photon fields [symbol] , Med Phys, vol. 35, no. 10, p. 4671-4684, October 2008; W. U. Laub et T. Wong, [symbol] The volume effect of detectors in the dosimetry of small fields used in IMRT [symbol] , Med Phys, vol. 30, no. 3, p. 341-347, mars 2003; I. J. Das, G. X. Ding, et A. Ahnesjo, [symbol] Small fields: Nonequilibrium radiation dosimetry [symbol] , Medical Physics, vol. 35, no. 1, p. 206-215, 2008; F. Verhaegen, I. J. Das, et H. Palmans, [symbol] Monte Carlo dosimetry study of a 6 MV stereotactic radiosurgery unit [symbol] , Phys Med Biol, vol. 43, no. 10, p. 2755-2768, oct. 1998). These studies showed the large differences between OFs measured with ionization chambers, silicon diodes, films, thermo-luminescent detectors (TLD) and natural diamonds in fields smaller than 3 cm×3 cm. The large active volume of detectors, their non-tissue equivalence, and the lack of lateral electronic equilibrium are the main causes of these broad results.

Recently diamond has been quoted in several papers as a good candidate as a small beam dosimeter (W. U. Laub et T. Wong, [symbol] The volume effect of detectors in the dosimetry of small fields used in IMRT [symbol] , Med Phys, vol. 30, no. 3, p. 341-347, mars 2003; D. Tromson, M. Rebisz-Pomorska, N. Tranchant, A. Isambert, F. Moignau, A. Moussier, B. Marczewska, et P. Bergonzo, [symbol] Single crystal CVD diamond detector for high resolution dose measurement for IMRT and novel radiation therapy needs [symbol] , in Diamond and related materials, vol. 19, p. 1012-1016; S. Almaviva, I. Ciancaglioni, R. Consorti, F. De Notaristefani, C. Manfredotti, M. Marinelli, E. Milani, A. Petrucci, G. Prestopino, C. Verona, et G. Verona-Rinati, [symbol] Synthetic single crystal diamond dosimeters for Intensity Modulated Radiation Therapy applications [symbol] , Nuclear instruments & methods in physics research. Section A, Accelerators, spectrometers, detectors and associated equipment, vol. 608, no. 1, p. 191-194; I. Ciancaglioni, M. Marinelli, E. Milani, G. Prestopino, C. Verona, G. Verona-Rinati, R. Consorti, A. Petrucci, et F. De Notaristefani, [symbol] Dosimetric characterization of a synthetic single crystal diamond detector in clinical radiation therapy small photon beams [symbol] , Med Phys, vol. 39, no. 7, p. 4493-4501, juill. 2012; G. T. Betzel, S. P. Lansley, F. Baluti, L. Reinisch, et J. Meyer, [symbol] Clinical investigations of a CVD diamond detector for radiotherapy dosimetry [symbol] , Phys Med, vol. 28, no. 2, p. 144-152, avr. 2012).

Diamond is nearly tissue-equivalent because of its atomic number (Z=6) close to human tissue effective atomic number (Z_{eff}˜7.42). A small active volume of diamond detector allows a high spatial resolution of dose measurement, the high density of atoms in lattice (10²³ atoms·cm⁻³) keeps a high signal-to-noise ratio and diamond electronic properties permit to achieve fast detector response. Many authors have studied natural diamond dosimeter commercialized by PTW (A. Fidanzio, L. Azario, R. Miceli, A. Russo, et A. Piermattei, [symbol] PTW-diamond detector: dose rate and particle type dependence [symbol] , Med Phys, vol. 27, no. 11, p. 2589-2593, nov. 2000; P. W. Hoban, M. Heydarian, W. A. Beckham, et A. H. Beddoe, [symbol] Dose rate dependence of a PTW diamond detector in the dosimetry of a 6 MV photon beam [symbol] , Phys Med Biol, vol. 39, no. 8, p. 1219-1229, août 1994; C. D. Angelis, S. Onori, M. Pacilio, G. A. P. Cirrone, G. Cuttone, L. Raffaele, M. Bucciolini, S. Mazzocchi. [symbol] An investigation of the operating characteristics of two PTW diamond detectors in photon and electron beams. [symbol] , Med. Phys., vol. 29, p. 248-254, 2002).

Thus, the non-reproducibility between devices, the high cost and the long delivery times are the main drawbacks for these detectors.

Synthetic diamond is a good alternative because reproducible and optimized growth conditions permit to obtain diamond with good electronic properties and to avoid impurity incorporation. The performances of such synthetic single crystal CVD for X-ray detectors were presented by various authors (S. Almaviva, I. Ciancaglioni, R. Consorti, F. De Notaristefani, C. Manfredotti, M. Marinelli, E. Milani, A. Petrucci, G. Prestopino, C. Verona, et G. Verona-Rinati, [symbol] Synthetic single crystal diamond dosimeters for Intensity Modulated Radiation Therapy applications [symbol] , Nuclear instruments & methods in physics research. Section A, Accelerators, spectrometers, detectors and associated equipment, vol. 608, no. 1, p. 191-194; G. T. Betzel, S. P. Lansley, F. Baluti, L. Reinisch, et J. Meyer, [symbol] Clinical investigations of a CVD diamond detector for radiotherapy dosimetry [symbol] , Phys Med, vol. 28, no. 2, p. 144-152, avr. 2012; N. Tranchant, D. Tromson, C. Descamps, A. Isambert, H. Hamrita, P. Bergonzo, et M. Nesladek, [symbol] High mobility single crystal diamond detectors for dosimetry: Application to radiotherapy [symbol] , Diamond and Related Materials, vol. 17, no. 7-10, p. 1297-1301, juill. 2008; Y. Garino, A. Lo Giudice, C. Manfredotti, M. Marinelli, E. Milani, A. Tucciarone, et G. Verona-Rinati, [symbol] Performances of homoepitaxial single crystal diamond in diagnostic x-ray dosimetry [symbol] , Applied Physics Letters, vol. 88, no. 15, p. 151901-151901-3, avr. 2006; F. Schirru, K. Kisielewicz, T. Nowak, et B. Marczewska, [symbol] Single crystal diamond detector for radiotherapy [symbol] , Journal of Physics D: Applied Physics, vol. 43, no. 26, p. 265101, juill. 2010).

However, an error in the dosimeter response with small beams appears when non-optimized bias of device is applied and further error in dosimeter response appears due to the density of diamond (3.51) compared with the one of water when sensitive diamond volume is high as observed for classical diamond dosimeter.

One of the aims of the present invention is to provide an optimized single crystal diamond dosimeter (SCDDo) presenting a small sensitive volume compared to the size of the irradiation field, thus avoiding the dose underestimation with classical diamond dosimeters, a high signal-to-noise ratio, and permitting to achieve fast detector response.

Another aim of the invention is to provide a waterproof diamond dosimeter having the appropriate properties of accuracy and precision, linearity, dose dependence, dose rate dependence and spatial resolution, enabling to give the knowledge of the absorbed irradiation.

Another aim of the present invention is the use of said dosimeter for stereotactic radiotherapy with small beams.

The Inventors have unexpectedly found that the combination of the covering of each set of electrode of at least 75% of the surface of their respective side and the diminution of the diamond thickness was providing a diamond dosimeter having not the problems encountered with classical diamond dosimeters such as an overestimation of the dosimeter response due to the bias caused by the density of diamond.

The present invention relates to a diamond dosimeter comprising a detector constituted by:
a single crystal diamond presenting two parallel planar sides (1, 2) and an edge (3), said two planar sides being spaced by a thickness (3′) corresponding to the height of the edge, and exhibiting a volume of crystal from about 0.06 mm³ to about 0.27 mm³,
two sets of electrode (4, 4′), each of them being deposited on each side (1, 2) of the single crystal diamond, wherein each set of electrode covers independently from each other at least 75% of the surface of said side,
wherein the sensitive volume is from about 0.06 mm³ to about 0.2 mm³,
wherein the edge (3) of the single crystal diamond is substantially devoid of electrode material and wherein the sets of electrode are not surrounded by a guard ring.

In all the specification, the surface covered by the set of electrode deposited on one side of said diamond will be designated by “covering surface”.

The inventors have unexpectedly found that contrary to the usual practice in the field of dosimeters, in particular for small beams, the ratio between the surface of each set of electrode covering the diamond and the surface of the diamond side must be higher than about 75%.

If said ratio is lower than 75%, all the charge created in the vicinity of the electrodes are not necessary collected and the ratio of charge collected depends on the bias applied on diamond. This implies an error on the charge measurement if not optimised bias is applied.

The Inventors have also unexpectedly found that contrary to the usual practice in the field of detectors, a guard ring was not necessary with the diamond dosimeter of the invention although, said dosimeter will be used for small beams.

A “dosimeter” is a measuring device used to detect, measure or evaluate and record ionizing radiation, such as X-rays, alpha particles, beta particles, gamma rays, protons, hadrons neutrons and all particles involved in the interaction of ionising radiation with matter.

The diamond dosimeter is in particular a synthetic diamond presenting an epitaxial layer on a diamond substrate or a synthetic diamond presenting an epitaxial layer on a hetero-substrate (i.e. any substrate which is not diamond on which diamond growth occurs), in particular such as iridium, silicon, silicon carbide . . . .

The term [symbol] detector [symbol] refers to means for detecting, measuring and recording ionizing radiation, such as X-rays, alpha particles, beta particles, gamma rays or any particles induced by the interaction of ionising radiation with the matter constituting the dosimeter.

The expression “single crystal diamond” refers to a diamond constituted of an individual crystal in opposition to a polycrystalline crystal diamond that is constituted of thousands or more individual crystal diamonds with coalescence and grain boundaries between individual crystals.

The single crystal diamond is a 3D diamond which can have any possible shape provided that it presents two sides (1, 2) that are planar and parallel, the height of the edge (3) between said two planar and parallel sides constituting the thickness of the shape. The volume which is delimited by the two planar parallel sides and the edge is not an empty space and is a full volume.

Said two planar sides can be different or identical.

FIG. 1 presents an example of such a shape but without limitation to the representation, and showing the two planar and parallel sides (1) and (2) spaced by the edge (3).

The volume of said diamond crystal is comprised from about 0.06 mm³ to about 0.27 mm³, in particular from 0.06 mm³ to 0.27 mm³, more particularly 0.06 mm³ to less than 0.27 mm³.

Below 0.06 mm³, the size of the dosimeter is too small to measure low dose rate in particular field of small beam dosimetry or IMRT (Intensity Modulated Radiation Therapy) or any conventional radiotherapy with low dose rate.

The dosimeter response can be obtained by the direct measurement of the charge with an electrometer or by the integration of the current measure in function of the time with an electrometer and an associated data acquisition system.

Above 0.27 mm³, said diamond presents the drawbacks presented above.

The term “electrode” refers to an electrical conductor or semi-conductor or conductive material.

The expression “set of electrode” refers to one electrode or a stacking up of electrodes Said electrode can be constituted by one material corresponding to an electrode material or by a stacking up of different materials corresponding to a stacking up electrode material.

The term “deposited” means that each electrode material is in stable contact with the one of the diamond parallel planar sides, and said contact being achieved by processes well known for a man skilled in the art.

The expression “each set of electrode covers independently from each other at least 75% of the surface of said side” means that each side of the diamond can be covered by a set of electrode presenting two different surfaces, provided that each set of electrode covers at least 75% of the surface of the side of the diamond on which it is deposited. In other words, it means that the ratio between the surface of the side and the surface of the set of electrode is at least 75%.

FIG. 2 shows an example of the covering surface of one set of electrode (4) on the side (1). On the other side (2), the second set of electrode (4′) covers said side (4′).

As an example, but without being limiting to it, the set of electrode (4) can cover 80% of the surface of the side (1) and the set of electrode (4′) can cover 90% of the surface of the side (2). Alternatively, the set of electrode (4) can cover 90% of the surface of the side (1) and the set of electrode (4′) can cover 80% of the surface of the side (2).

Each set of electrode (4) and (4′) can also have the same covering surface on its respective side.

The expression “sensitive volume” refers to the volume of diamond delimited between both sets of electrode (4) and (4′).

In other word, it corresponds to the volume where at least 90%, in particular 100% of the charges can be collected.

From 75% of surface covering by the sets of electrode, at least 90%, in particular 100% of the charges of the irradiation beam can be collected.

In the case where both sets of electrode have a similar surface, said sensitive volume corresponds to the result of the product of the covering surface of one set of electrode (4) or (4′) with the height of the edge (3).

In the case where each set of electrode exhibits a different surface, it corresponds to the volume where the electrical field applied is high enough to gain the charge collection.

In all the specification the expressions “sensitive volume” and “active volume” can be used and have the same meaning.

The “sensitive volume is comprised from about 0.06 mm³ to about 0.2 mm³” means that the maximum sensitive volume corresponds to the total volume of the diamond. In this case, each set of electrode substantially covers 100% of its respective side of the diamond.

In the case where each set of electrode covers only 75% of its respective side, the minimal value of the diamond crystal volume is 0.08 mm³ to have a sensitive volume of at least 0.06 mm³ for a thickness equal to 0.2 mm.

Below 0.06 mm³, the sensitive volume is too small to measure the signal induced in dosimeter with low dose rate.

Above 0.20 mm³ of sensitive volume, said diamond presents the drawbacks presented above.

The expression “substantially devoid of electrode material” means that the edge (3) of the diamond is not covered by the sets of electrode (4, 4′).

It can also mean that said edge is partially covered by each electrode material deposited on each respective side (1, 2), provided that the distance separating each electrode material deposited is at least 20 μm. If said distance is lower than 20 μm, the dosimeter is unable to function because a short cut between said two sets of electrodes will then occur.

There is advantageously no electrode material (or 0% of electrode material) on the edge of the diamond, whatever the shape of the diamond.

As an example, if the diamond is a parallelepiped having four edges, there is 0% of electrode material on said four edges.

The expression “wherein the sets of electrode are not surrounded by a guard ring” means that the diamond is totally free of a guard ring.

Thus one of the advantages of the invention is to provide a diamond exhibiting a very small sensitive volume giving thus the properties cited above but avoiding the surrounding of a guard ring that is not conceivable in this case due to the size of small beams.

In an advantageous embodiment, the sensitive volume of the diamond dosimeter defined above is from about 0.06 mm³ to about 0.1 mm³, in particular from about 0.1 mm³ to about 0.2 mm³.

In an advantageous embodiment, the present invention relates to a diamond dosimeter as defined above, wherein the ratio signal to noise is higher than 1000 for a classical rate of 400 monitor units per minute (MU/min).

In an advantageous embodiment, the present invention relates to a diamond dosimeter as defined above, wherein the thickness varies from about 0.06 mm to about 0.2 mm.

In an advantageous embodiment, the present invention relates to a diamond dosimeter as defined above, substantially devoid of leakage currents (in the pA range), avoiding additive perturbation in the lack of electronic lateral equilibrium, presenting a ratio signal to noise of at least 1000 for a classical rate of about 400 MU/min, and enables to measure OF for field size from 3-4 mm to 20 mm.

The output factor may be determined as the ratio of corrected dosimeter readings measured under given set of non-reference conditions to that measured under reference conditions. These measurements are typically done as the depth of the maximum dose or at the reference depth.

Leakage current is the current that flows out of the intended circuit i.e. between the two diamond sets of electrode or between the conductive triaxial conductors. A protective ground is deposited and connected to the ground conductor in order to minimize the signal perturbation (fluctuation) cause by electromagnetic waves. In the absence of a grounding connection, the signal will not be stable and will fluctuate according to time leading to a wrong dose reading.

For small beam there is a lack in electronic lateral equilibrium (ELE); in that case dose deposited in the detector by secondary electrons could be wrong due to the non tissue-equivalence (density and composition). Diamond having an atomic number close to the one of human tissue, it minimizes this problem. The dimension of the diamond must be optimized in order to have a small influence on the output factor (OF) and to keep a high ratio signal to noise, i.e. of about 1000.

A compromise between the thickness of the diamond and its lateral dimensions must be found and it is another advantage of the invention to provide a diamond presenting said compromise and thus a volume from about 0.06 mm³ to about 0.27 mm³ defined above allowing thus to measure OF values for field size from 3-4 mm to 20 mm (3 mm for leaves width and 4 mm for circular fields).

The diamond of the invention allows thus to carry out measures for which the influence of the density of the diamond is reduced and to reach a spatial resolution necessary for a use in small beams dosimeter.

In an advantageous embodiment, the present invention relates to a diamond dosimeter as defined above, wherein said two planar sides are identical.

In an advantageous embodiment, the present invention relates to a diamond dosimeter as defined above, wherein said two planar sides each present a surface of about 0.30 mm² to about 1 mm², in particular 1 mm².

In the case of small beams, all the elements constituting the dosimeter have an influence on the measurement of the measured charge induced by irradiation.

Errors on the calculation of the irradiation dose to be delivered to the patient, such as an underestimation of the measured dose compared to the “real” dose, lead to the administration of an excessive dose. In order to avoid this drawback, the size of the diamond must not be high in comparison with the irradiation field (as an example, a dosimeter volume of 0.3 cm³ is too high compared with a field size with a diameter equal to 30 mm).

In an advantageous embodiment, the present invention relates to a diamond dosimeter as defined above, said two planar sides presenting a surface of about 0.30 mm² to about 1 mm², in particular 1 mm², wherein said two sides are spaced by a thickness from about 60 μm to about 200 μm, in particular from about 88 to about 200 μm.

The Inventors have unexpectedly found that the diamond must not only have a volume comprised from about 0.06 mm³ to about 0.2 mm³, combined to a surface of the sides (1, 2), as small as possible (in particular said surface is comprised from about 0.30 mm² to about 1 mm², in particular 1 mm²), but also a thickness (height) of the edge (3) that must be comprised from about 60 μm to about 200 μm, in particular from about 88 to about 200 μm, in order to keep a signal to noise ratio higher than 1000 for a classical dose rate of 400 monitor units per minute (MU)/min while a man skilled in the art would have been motivated to increase the thickness in order to keep a ratio signal to noise higher than 1000.

Moreover, a minimal thickness can be defined in function of the side area.

Table 1 below presents the minimal height of the edge (3) (i.e. thickness) of the diamond to obtain a signal to noise ratio higher than 1000 for a classical dose rate of 400 monitor units per minute (MU)/min as determined by the Inventors. Said thickness is the minimal and can therefore be higher than the indicated number for a defined side area.

TABLE 1

| Side area (1) and | minimal height of |
|---|---|
| (2) (mm²) | the edge (3) (μm) |
| 1.00 | 59 |
| 0.95 | 62 |
| 0.90 | 65 |
| 0.85 | 69 |
| 0.80 | 73 |
| 0.75 | 78 |
| 0.70 | 84 |
| 0.65 | 90 |
| 0.60 | 98 |
| 0.55 | 107 |
| 0.50 | 117 |
| 0.45 | 130 |
| 0.40 | 146 |
| 0.35 | 167 |
| 0.30 | 195 |

In an advantageous embodiment, the present invention relates to a diamond dosimeter as defined above, said two planar sides presenting each a surface of about 0.30 mm² to about 1 mm², in particular 1 mm²,

wherein said two planar sides are spaced by a thickness from about 60 μm to about 100 μm, in particular from about 100 to about 150 μm, more particularly from about 150 to about 200 μm.

In an advantageous embodiment, the present invention relates to a diamond dosimeter as defined above,

wherein said two planar sides present a surface of about 1 mm² and are spaced by a thickness comprised from 60 μm to about 200 μm, in particular from 100 μm to about 165 μm, more particularly 165 μm.

In an advantageous embodiment, the present invention relates to a diamond dosimeter as defined above, said two planar sides presenting a surface of about 1 mm², wherein said two planar sides are spaced by a thickness of about 60 μm.

In an advantageous embodiment, the present invention relates to a diamond dosimeter as defined above, wherein each set of electrode covers at least 80% of each planar side, in particular at least 90% of each planar side, more particularly at least 95% of each planar side.

The Inventors have unexpectedly found that contrary to the usual practice in the field of dosimeters, in particular for small beams, the ratio between the surface of the set of electrode covering the diamond and the surface of the diamond side must be higher than about 80%, in particular higher than 90%, more particularly higher than about 95%.

The more the set of electrode covers the planar side, the more the percentage of charge can be collected.

In other words, the highest the surface of each set of electrode is, the more homogenous the electric field is and lesser the error charge measurement and the dose rate dependency are.

Further, the Inventors have unexpectedly found that the covering surface of each set of electrode must be as high as possible combined with a volume of the diamond which should be as low as possible.

In an advantageous embodiment, the present invention relates to a diamond dosimeter as defined above, said two planar sides presenting a surface of about 1 mm² and being spaced by a thickness of about 60 μm,

wherein each set of electrode covers at least 80% of each planar side, in particular at least 90% of each planar side, more particularly at least 95% of each planar side.

In an advantageous embodiment, the present invention relates to a diamond dosimeter as defined above, wherein each set of electrode covers substantially 100% of each planar side.

The term “substantially” for the covering surface of each set of electrode means that each set of electrode covers from 95% to 100% of the diamond side.

Preferably, the set of electrode covers almost the totality up to the totality of the diamond side in order to reduce the bias effect in the dose rate dependency of the detector.

100% of covering allows to gain easily a saturated I(V) characteristic thus to collect 100% of the charges induced in the dosimeter by the radiation beam.

In an advantageous embodiment, the present invention relates to a diamond dosimeter as defined above, said two planar sides presenting a surface of about 1 mm² and being spaced by a thickness of about 60 μm,

wherein each set of electrode covers substantially 100% of each planar side.

100% of covering allows to gain easily a saturated I(V) characteristic and then to collect 100% of the charges induced in the dosimeter by the radiation beam.

In an advantageous embodiment, the present invention relates to a diamond dosimeter as defined above, wherein said two parallel planar sides are rectangular.

FIG. 3 presents an example of such a dosimeter but without being limited to it.

In an advantageous embodiment, the present invention relates to a diamond dosimeter as defined above, wherein said two parallel planar sides are circular.

FIG. 4 presents an example of such a dosimeter but without being limited to it.

In an advantageous embodiment, the present invention relates to a diamond dosimeter as defined above, wherein said two parallel planar sides are square.

FIG. 5 presents an example of such a dosimeter but without being limited to it.

One of the advantages of the square shape comes from the homoepitaxial substrates that are commercially available under a square shape allowing to say square shape to be formed during the homothetic growth of the diamond.

Another advantage is the easiest handling of a square shape during the manufacturing of the dosimeter.

It is to be noted that in the case where the planar sides are square, the value of the square length is far greater than the value of the thickness above defined.

In an advantageous embodiment, the present invention relates to a diamond dosimeter as defined above, said two planar sides presenting a surface of about 1 mm² and being spaced by a thickness of about 60 μm and each set of electrode covers substantially 100% of each planar side,

wherein said two parallel planar sides are square.

In an advantageous embodiment, the present invention relates to a diamond dosimeter as defined above, wherein the material of said sets of electrode has a Z of about 5 to about 28.

The letter “Z” refers to the atomic number.

All the constitutive materials of the dosimeter have an influence on the measure of the irradiation dose and thus the atomic number of the material of the sets of electrode must be close to the one of human tissues.

Above 28, the thickness of the sets of electrode must be adapted to avoid the problems caused by the density difference of the sets of electrode on diamond compared to water.

In an advantageous embodiment, the present invention relates to a diamond dosimeter as defined above, wherein each set of electrode presents a thickness from about 0.01 μm to about 100 μm, preferably of about 0.01 μm to about 10 μm, more preferably of about 0.01 μm to about 0.5 μm, in particular about 0.1 μm.

In the case of electrode material presenting a low atomic number (Z), the thickness of the sets of electrode has an insignificant influence on the measure of the dose if its thickness is not higher than 100 μm.

In an advantageous embodiment, the present invention relates to a diamond dosimeter as defined above, wherein each set of electrode presents a thickness from about 10 μm to about 100 μm.

Although the thickness of the sets of electrode influences the measure of the dose, it can be increased up to 100 μm and do not influence significantly the measured dose.

Above 100 μm, the thickness is too high and influence significantly the measure of the dose.

In an advantageous embodiment, the present invention relates to a diamond dosimeter as defined above, wherein the material of said sets of electrode has a Z of about 5 to about 28, each set of electrode presenting a thickness from about 0.01 μm to about 100 μm, preferably of about 0.01 μm to about 10 μm, more preferably of about 0.01 μm to about 0.5 μm, in particular about 0.1 μm,

wherein the material of said sets of electrode is carbon selected from the group consisting of conductive amorphous carbon or non-organized carbon, Diamond Like Carbon (DLC), conductive diamond (P-type doping, N-type doping, implanted diamond or diamond with defects), graphite, non-organized graphite, amorphous carbon nitrite (aCNx), glassy carbon, conductive carbon ink, conductive polymer or the material of said sets of electrode is a metal selected from the group consisting of Al, C, Si, Cr, Ni, Ti, in particular Al.

The expression “conductive amorphous carbon” is a free, reactive carbon that does not have any crystalline structure liable to conduct the current.

The “Diamond Like Carbon” exists in different forms of amorphous carbon materials that display some of the typical properties of diamond.

The diamond is naturally non conductive and must be doped or damaged to exhibit semiconductive properties. Doping can be carried out by techniques well known for a man skilled in the art.

Graphite is an allotrope of carbon that is an electrical conductor.

The material of each set of electrode (4, 4′) deposited on each side (1, 2) can be similar or different.

In an advantageous embodiment, the present invention relates to a diamond dosimeter as defined above, wherein the material of said sets of electrode has a Z higher than 28.

In an advantageous embodiment, the present invention relates to a diamond dosimeter as defined above, the material of said sets of electrode having a Z higher than 28, in particular Ag, Au or Pt,

wherein each set of electrode presents a thickness from about 0.01 μm to about 1 μm, preferably of about 0.02 μm to about 1 μm, in particular about 0.2 μm, in particular said set of electrode are constituted of a stacking up of electrodes, in particular Ti/Au with a respective thickness of each stacking up of about 2 nm and about 50 nm or a Ti/Pt/Au stacking up with a respective thickness of each stacking up of 5-10 nm, 50 nm and 500 nm.

In the case of an electrode material presenting a high atomic number (Z), the thickness of the sets of electrode has a significant influence on the measure of the dose above 1 μm.

In particular, said sets of electrode are constituted of gold.

In particular, said sets of electrode are constituted of ITO (Indium Tin Oxide).

ITO is a mixture of indium(III) oxide (In₂O₃) and tin(IV) oxide (SnO₂), particularly containing 90% In₂O₃, 10% SnO₂ by weight.

Sets of electrode are usually deposited on the diamond in one layer.

However, they can also be deposited under the form of a stacking up of two or three layers of electrodes constituted of different material all with a Z higher than 28 having different thicknesses provided that the total thickness is comprised from 0.01 μm to 1 μm.

The material of each set of electrode (4, 4′) deposited on each side (1, 2) can be similar or different.

In an advantageous embodiment, the present invention relates to a diamond dosimeter as defined above, wherein the sets of electrode have a similar shape and the material of each of them is the same,

in particular chosen from carbon selected from the group consisting of conductive amorphous carbon or non-organized carbon, Diamond Like Carbon (DLC), conductive diamond (P-type doping, N-type doping, implanted diamond or diamond with defects), graphite, non-organized graphite, amorphous carbon nitrite (aCNx), glassy carbon, conductive carbon ink, conductive polymer, or the material of said sets of electrode is a metal selected from the group consisting of Al, C, Si, Cr, Ni, in particular Al, or

in particular constituted of a stacking up of electrodes, in particular Ti/Au or Cr/Au with a respective thickness of each stacking up of about 2 nm and about 50 nm or a Ti/Pt/Au stacking with respective thickness of 5-10 nm, 50 nm and 500 nm or in particular constituted of ITO (Indium Tin Oxide)

In this embodiment, both set of electrode are strictly similar.

In an advantageous embodiment, the present invention relates to a diamond dosimeter as defined above, wherein the sets of electrode have a similar shape and are respectively of two different materials chosen in particular from gold-nickel, chrome-nickel, silver-nickel.

In this embodiment, both sets of electrode are constituted of two different materials to provide blocking contacts, or to provide a diode characteristic to the diamond dosimeter.

In an advantageous embodiment, the present invention relates to a diamond dosimeter as defined above, wherein the sets of electrode have a similar shape,

one of said set of electrode having a Z of about 5 to about 28, and presenting a thickness from about 0.01 μm to about 100 μm, preferably of about 0.01 μm to about 10 μm, more preferably of about 0.01 μm to about 0.5 μm, in particular about 0.1 μm,

the other set of electrode having a Z higher than 28 and presenting a thickness from about 0.01 μm to about 1 μm, preferably of about 0.02 μm to about 1 μm, in particular about 0.2 μm, in particular said other set of electrode is constituted of a stacking up of electrodes, in particular Ti/Au with a respective thickness of each stacking up of about 2 nm and about 50 nm or a Ti/Pt/Au stacking up with a respective thickness of each stacking up of 5-10 nm, 50 nm and 500 nm, in particular ITO.

The material of each set of electrode is as defined above.

In an advantageous embodiment, the present invention relates to a diamond dosimeter as defined above, comprising two conductive wires (5, 5′) connecting the sets of electrode to a triaxial cable (6).

A triaxial cable is a type of electrical cable similar to coaxial cable (presenting an inner conductor surrounded by a tubular insulating layer, surrounded by a tubular conducting shield, surrounded by a plastic), but with the addition of an extra layer of insulation and an additional conducting sheath. It provides greater bandwidth and rejection of interference than coaxial cable.

The sets of electrode must be connected to said triaxial cable, which itself is connected to a device liable to measure the electrical current or charge and determine the dose of irradiation.

In an advantageous embodiment, the present invention relates to a diamond dosimeter as defined above, comprising two conductive wires (5, 5′) connecting the sets of electrode to a triaxial cable (6),

wherein the triaxial cable (6) comprises a central core (7) and guard (8).

The guard (8) is present to give an external shielding.

In an advantageous embodiment, the present invention relates to a diamond dosimeter as defined above, comprising two conductive wires (5, 5′) connecting the sets of electrode to a triaxial cable (6), the triaxial cable (6) comprising a central core (7) and guard (8).

wherein the material of said two conductive wires is aluminium, silicon, carbon, nickel, and their alloys.

In an advantageous embodiment, the present invention relates to a diamond dosimeter as defined above, comprising two conductive wires (5, 5′) connecting the sets of electrode to a triaxial cable (6), the triaxial cable (6) comprising a central core (7) and guard (8).

wherein the conductive wires have a thickness of less than 100 μm, in particular comprised from about 20 μm to about 100 μm.

As all the elements constituting the dosimeter are important for the measure of the dose, the thickness of the wires must be controlled.

Below 20 μm, the thickness of the wires is too small to be handled.

Above 100 μm, the thickness is too high and influences the measure of the dose.

In an advantageous embodiment, the present invention relates to a diamond dosimeter as defined above, comprising two conductive wires (5, 5′) connecting the sets of electrode to a triaxial cable (6), the triaxial cable (6) comprising a central core (7) and guard (8).

wherein said two conductive wires are connected to said crystal diamond by connecting means chosen among conductive glue, in particular selected form the group consisting of graphite, a graphite charged epoxy resin or carbon charged epoxy resin, carbon conductive paste, or by bonding.

In an advantageous embodiment, the present invention relates to a diamond dosimeter as defined above, comprising two conductive wires (5, 5′) connecting the sets of electrode to a triaxial cable (6), the triaxial cable (6) comprising a central core (7) and guard (8), said two conductive wires being connected to said crystal diamond by connecting means chosen among conductive glue, in particular selected form the group consisting of graphite or a graphite charged epoxy resin, or carbon charged epoxy resin, carbon conductive paste or by bonding,

wherein one of said wires is connected on its upper extremity to one set of electrode of said single crystal diamond and on its lower extremity to said triaxal cable and the second wire is connected on its upper extremity to the second set of electrode of said single crystal diamond and on its lower extremity to said central core of said triaxal cable.

One of the wires is connected from one set of electrode to the central core.

The second wire is connected from the second set of electrode to the external mass of the triaxial cable.

In an advantageous embodiment, the present invention relates to a diamond dosimeter as defined above, further comprising a support in which said single crystal diamond is mounted.

The support can be constituted with any material compatible with the other elements and with low currents. As the support also influences the measure of the dose, it must also be constituted of materials as close as possible to tissue equivalence.

The expression “tissue equivalent” refers to a material that should have the same absorption and scatter properties as human tissue for the selected range of photon or electron energies used clinically.

As an example, the support may be: in Polymethylmethacrylat (PMMA), Polybenzylmethacrylate (PBzMA), crosslinked polystyrene, Solid Water (SW), Polydimethylsiloxane (PDMS), virtual water.

The support can be made of a unique material or can be made of distinct materials such as two materials.

As an example, FIG. 9A presents a diamond dosimeter with a support.

In an advantageous embodiment, the present invention relates to a diamond dosimeter as defined above,

wherein said support is constituted of two parts,
an upper part comprising the single crystal diamond and the sets of electrode,
a lower part comprising the triaxial cable,
said upper and lower parts being contiguous, the bottom of the upper part being adjacent to the top of the lower part,

the conductive wires extending from their upper extremities connected to the sets of electrode through the lower part of the support.

The expression “two lower and upper parts are contiguous and adjacent” means that both parts are linked together without any additional part separating said lower and upper part.

This case corresponds for instance to the situation where the support is made of two distinct materials, each material corresponding to respectively to the upper part and the lower part above defined

As an example, FIG. 9B present a diamond dosimeter with a support in two parts.

In an advantageous embodiment, the present invention relates to a diamond dosimeter as defined above, wherein said dosimeter is waterproof.

For an application in radiotherapy, said dosimeter must be waterproof.

In an advantageous embodiment, the present invention relates to a diamond dosimeter as defined above, wherein the totality of the single crystal diamond is mounted in the upper part of the support.

In this embodiment, the diamond dosimeter is localized only in the upper part and the lower part is substantially or completely free of said diamond dosimeter.

In an advantageous embodiment, the present invention relates to a diamond dosimeter as defined above, wherein a first portion of the single crystal diamond is mounted in the upper part and the remaining portion of said single crystal diamond is in the lower part of the support.

In this embodiment, the diamond is only partially localized in the upper part, the other portion of the diamond being in the lower part of said support.

Advantageously, the portion present in the upper part is from ⅓ to ⅔ of the length of the dosimeter depending on the size of the diamond dosimeter

In an advantageous embodiment, the present invention relates to a diamond dosimeter as defined above, presenting a symmetry axis.

The symmetry axis is well known for a man skilled in the art.

In an advantageous embodiment, the present invention relates to a diamond dosimeter as defined above, wherein said single crystal diamond is mounted in the symmetry axis of said support, the length of the single crystal diamond inside the upper part being comprised from about 0.2 mm to about 1.2 mm.

Thus the diamond dosimeter is centred according to x and y axis of the diamond dosimeter.

In an advantageous embodiment, the present invention relates to a diamond dosimeter as defined above, wherein said upper part of said support is constituted with a first polymer, in particular with polybenzylmethacrylate (PBzMA), provided that said first polymer is compatible with said connected means.

The expression “said first polymer is compatible with said connected means” means that said polymer must not react with the connecting means, in particular the glue or must not fuse the connecting means, in particular the glue due to the high temperature of the polymerization reaction.

In particular, said first polymer is different from PMMA.

In the description, PBzMA and PBnMA can be used and refer to the same compound.

In an advantageous embodiment, the present invention relates to a diamond dosimeter as defined above, said upper part of said support being constituted with a first polymer,

wherein said lower part of said support is constituted of a second polymer, identical or different from the first polymer, in particular selected from the group consisting of materials as close as possible to the tissue equivalence: Polymethylmethacrylat (PMMA), Polybenzylmethacrylate (PBzMA), crosslinked polystyrene, Solid Water (SW), Polydimethylsiloxane (PDMS), virtual water.

Styrene can be copolymerized with other monomers; for example, divinylbenzene can be used for cross-linking the polystyrene chains.

Solid Water® (commercially available at CNMC, 865 Easthagan Drive, Nashville, Tenn. 37217 USA) mimics the absorption characteristics of water over a wide range of energies and is commercially available.

The expression “virtual water” mimics the absorption characteristics of water over a wide range of energies and is commercially available, for example at CNMC, 865 Easthagan Drive, Nashville, Tenn. 37217 USA).

In an advantageous embodiment, the present invention relates to a diamond dosimeter as defined above, said upper part of said support being constituted with a first polymer, said lower part of said support being constituted of a second polymer, identical or different from the first polymer,

wherein said support or said lower part and said upper part of said support present a cylindrical form.

In an advantageous embodiment, the present invention relates to a diamond dosimeter as defined above, said upper part of said support being constituted with a first polymer, said lower part of said support being constituted of a second polymer, identical or different from the first polymer, said lower part and said upper part of said support presenting a cylindrical form

wherein the diameter of said support or of said lower part and of said upper part of said support is comprised from about 2 mm to about 6 mm.

Below 2 mm of diameter, the diameter is too small to introduce the diamond with its sets of electrode and the wires into said support.

Above 6 mm, the support is too large compared to the size of the usual dosimeter thus will not be adapted to the used support.

In an advantageous embodiment, the present invention relates to a diamond dosimeter as defined above, said upper part of said support being constituted with a first polymer, said lower part of said support being constituted of a second polymer, identical or different from the first polymer, said lower part and said upper part of said support presenting a cylindrical form the diameter of said lower part and of said upper part of said support being comprised from about 2 mm to about 6 mm,

wherein said single crystal diamond is located at about 0.5 mm to about 1.6 mm, in particular at about 0.5 mm to about 1 mm, from the top of the support or of the upper part.

Above 1.6 mm, the attenuation of the charge measured is too important in depth dose curve.

In an advantageous embodiment, the present invention relates to a diamond dosimeter as defined above, said upper part of said support being constituted with a first polymer, said lower part of said support being constituted of a second polymer, identical or different from the first polymer, said lower part and said upper part of said support presenting a cylindrical form the diameter of said lower part and of said upper part of said support being comprised from about 2 mm to about 6 mm, said single crystal diamond being located at about 0.5 mm to about 1 mm from the top of the upper part.

wherein the distance between the bottom of the single crystal diamond and the top of the triaxial cable is comprised from 1 cm to more than 3 cm, in particular between 3 and 4 cm.

Below 1 cm, the triaxial cable will trouble the measured dose because of the metallic wires of the triaxial cable that exhibit high Z.

Above 4 cm, the stiffness of the whole dosimeter will be too low. Thus, when one will handle it the dosimeter may break with the triaxial cable.

In an advantageous embodiment, the present invention relates to a diamond dosimeter as defined above, said upper part of said support being constituted with a first polymer, said lower part of said support being constituted of a second polymer, identical or different from the first polymer, said lower part and said upper part of said support presenting a cylindrical form, the diameter of said lower part and of said upper part of said support being comprised from about 2 mm to about 6 mm, said single crystal diamond being located at about 0.5 mm to about 1 mm from the top of the upper part, the distance between the bottom of the single crystal diamond and the top of the triaxial cable being comprised from 1 cm to more than 3 cm, in particular between 3 and 4 cm.

wherein said guard of said triaxial cable is brought back on the support to give an external shielding.

In an advantageous embodiment, the present invention relates to a diamond dosimeter as defined above, said upper part of said support being constituted with a first polymer, said lower part of said support being constituted of a second polymer, identical or different from the first polymer, said lower part and upper part of said support presenting a cylindrical form, the diameter of said lower part and upper part of said support being comprised from about 2 mm to about 6 mm, said single crystal diamond being located at about 0.5 mm to about 1 mm from the top of the upper part, the distance between the bottom of the single crystal diamond and the top of the triaxial cable being comprised from 1 cm to more than 3 cm, in particular between 3 and 4 cm.

wherein the support is devoid of an external shielding, in particular where said guard of said triaxial cable is not brought back on the support.

In an advantageous embodiment, the present invention relates to a diamond dosimeter as defined above, said upper part of said support being constituted with a first polymer, said lower part of said support being constituted of a second polymer, identical or different from the first polymer, said lower part and said upper part of said support presenting a cylindrical form, the diameter of said lower part and of said upper part of said support being comprised from about 2 mm to about 6 mm, said single crystal diamond being located at about 0.5 mm to about 1 mm from the top of the upper part, the distance between the bottom of the single crystal diamond and the top of the triaxial cable being comprised from 1 cm to more than 3 cm, in particular between 3 and 4 cm, said guard of said triaxial cable being brought back on the support to give an external shielding, comprising further an electrical isolation, in particular with a colloid graphite, a lacquer, a paint, a graphite epoxy resin or carbon charged epoxy resin, or carbon conductive paste, all around the cylindrical form of said first and second polymer, and wherein said guard is connected to said first polymer by said isolation wire.

Said external isolation is an advantageous embodiment of the dosimeter of the invention.

In an advantageous embodiment, the present invention relates to a diamond dosimeter as defined above, said upper part of said support being constituted with a first polymer, said lower part of said support being constituted of a second polymer, identical or different from the first polymer, said lower part and said upper part of said support presenting a cylindrical form, the diameter of said lower part and of said upper part of said support being comprised from about 2 mm to about 6 mm, said single crystal diamond being located at about 0.5 mm to about 1 mm from the top of the upper part, the distance between the bottom of the single crystal diamond and the top of the triaxial cable being comprised from 1 cm to 3 cm, said guard of said triaxial cable being brought back on the support to give an external shielding,

wherein said diamond dosimeter is a water equivalent.

The expression “water equivalent” refers to a material that exhibits absorption and scatter properties close to water properties for the selected range of photon or electron energies used clinically.

In an advantageous embodiment, the present invention relates to a diamond dosimeter as defined above, said upper part of said support being constituted with a first polymer, said lower part of said support being constituted of a second polymer, identical or different from the first polymer, said lower part and upper part of said support presenting a cylindrical form, the diameter of said lower part and upper part of said support being comprised from about 2 mm to about 6 mm, said single crystal diamond being located at about 0.5 mm to about 1 mm from the top of the upper part, the distance between the bottom of the single crystal diamond and the top of the triaxial cable being comprised from 1 cm to 3 cm, said guard of said triaxial cable being brought back on the support to give an external shielding,
wherein said diamond dosimeter is close to a tissue equivalent.

Therefore, said diamond dosimeter exhibits absorption and scatter properties close to the one of human tissue.

In another aspect the present invention relates to the use of a diamond dosimeter as defined above, for the implementation of a radiotherapy method, preferably radiotherapy using small beams, in particular stereotactic radiotherapy, radiotherapy in stereotactic conditions, intensity-modulated radiation therapy (IMRT), protontherapy particularly for PBS mode (pencil beam scanning mode) and hadrontherapy.

Stereotactic radiation therapy (SRT) comprises high-precision irradiation techniques that use multiple, non-coplanar photon radiation beams, and deliver a high dose of radiation to stereotactically localized lesions, applying frame-based and frameless techniques. These lesions were originally mainly located in the brain, but now also include a number of extra-cranial malignancies. With regard to dose fractionation, SRT is divided into stereotactic radiosurgery, in which the total dose is delivered in a single treatment session, and stereotactic radiotherapy, in which the total dose is delivered in multiple fractions, similar to standard radiotherapy.

The expression “radiotherapy in stereotactic conditions” is a form of radiation therapy that focuses radiation on a small area of the body having the advantage of better targeting the abnormal area while other types of radiation therapy are more likely to affect nearby healthy tissue.

The expression “intensity-modulated radiation therapy” refers to an advanced mode of high-precision radiotherapy that uses computer-controlled linear accelerators to deliver precise radiation doses to a malignant tumor or specific areas within the tumor.

### DESCRIPTION OF THE FIGURES

The invention will be further illustrated by the figures and examples.

FIG. 1 represents a general example of a diamond dosimeter of any shape showing the two parallel planar sides (1) and (2) spaced by a thickness corresponding to the height (3′) of the edge (3).

FIG. 2 represents an example of the covering of one set of electrode (4) on the side (1).

On the other side (2), the second set of electrode (4′) covers said side (2). The covering surfaces of the sets of electrode (4) and (4′) can be identical or different. In the case where the covering surfaces of the sets of electrode (4) and (4′) are different, the covering surface of the set of electrode (4) can be larger or smaller than the covering surface of the set of electrode (4′).

FIG. 3 represents an example of a dosimeter wherein each sides (1) and (2) are rectangular. The dosimeter is therefore parallelepiped.

FIG. 4 represents an example of a dosimeter wherein each sides (1) and (2) are circular. The dosimeter is therefore cylindrical.

FIG. 5 represents an example of a dosimeter wherein each sides (1) and (2) are square. The dosimeter is therefore parallelepiped.

FIGS. 6A to 6G represent the different steps of manufacture of the diamond dosimeter.

FIGS. 7A to 7G represent the different steps of manufacture of the diamond dosimeter with the details of constituents of the support.

FIGS. 8A to 8D represent the sizes of the different parts of the diamond dosimeter manufacture on FIGS. 6 and 7, with the dimensions of the constituents of the support.

FIGS. 9A to 9B represent the scheme of a water-equivalent SCDDo according to the invention (A) presenting a support in one part, (B) presenting a support with an upper part and a lower part.

FIG. 9C represents the X-rays radiography of FIG. 9(B).

FIG. 10 represents the I-V characteristic of the SCDDo measured with a 6 MV photon beam.

x-axis: voltage (V)

y-axis: current (A)

FIG. 11 represents the Dose linearity of the SCDDo (example 2) response in 10×10 cm² field at a dose rate of 400 MU·min⁻¹. Error bars are less than the height of data points (▪). Linear fit is plotted with solid line.

x-axis: Dose (MU)

y-axis: Charge collected (nC)

FIGS. 12A and 12B represent the Dose rate dependence of the SCDDo response in 10×10 cm² field, by changing the dose per pulse (SSD modification).

(a) Percentage variation of the measured charge normalized to the value at SSD of 100 cm. Error bars are less than the height of data points (▪).

x-axis: dose rate (cGy·min⁻¹)

y-axis: current (nA)

(b) Analyze with the Fowler's model. Fowler's equation fit is plotted with solid line. Δ=0.977±0.017.

x-axis: dose rate (cGy·min⁻¹)

y-axis: current (Q/Q_{DSP100cm}−1)×100

FIGS. 13A and 13B represent the Dose rate dependence of the SCDDo response in 10×10 cm² field, by changing the pulse repetition frequency.

(a) Percentage variation of the measured charge normalized to the value at 400 MU·min⁻¹. Error bars are less than the height of data points (▪).

x-axis: dose rate (cGy·min⁻¹)

y-axis: current (nA)

(b) Analyze with the Fowler's model. Fowler's equation fit is plotted with solid line. Δ=0.997±0.005.

x-axis: dose rate (cGy·min⁻¹)

y-axis: current (Q/Q_{400MU·min}_{^{−1}}−1)×100

FIGS. 14A and 14B represent the Cross-plane dose profiles measured with the SCDDo of the invention (example 2) (diamond), the PTW 60017 diode (square), the PTW 31014 PinPoint chamber (triangle) and a PTW 60003 diamond detector (star), for a 6MV photon beam, with a Varian Clinac 2100 C linac and a μMLC m3. Depth of measurements: 10 cm in water. SSD=100 cm. Normalization on beam axis.

(a) 0.6×0.6 cm² beam size.

x-axis: x (mm)

y-axis: relative dose (%)

(b) 10×10 cm² beam size.

x-axis: Y (mm)

y-axis: relative dose (%)

FIG. 15 represents the Depth dose curves measured with the SCDDo of the invention (example 2) (diamond), the PTW 60017 diode (square), and the PTW 31014 PinPoint chamber (triangle), for a 6MV photon beam, 0.6×0.6 cm² and 10×10 cm² field sizes, with a Varian Clinac 2100 C linac and a μMLC m3. SSD=100 cm. Normalization at dₘₐₓ.

x-axis: z (mm)

y-axis: relative dose (%)

FIG. 16A represents the output factors measured with the SCDDo of the invention (example 2) and a PTW 60003 diamond dosimeter (star), for 6MV photon beam, with a Varian Clinac 2100 C linac and a μMLC m3. Depth of measurements: 10 cm in water. SSD=100 cm.

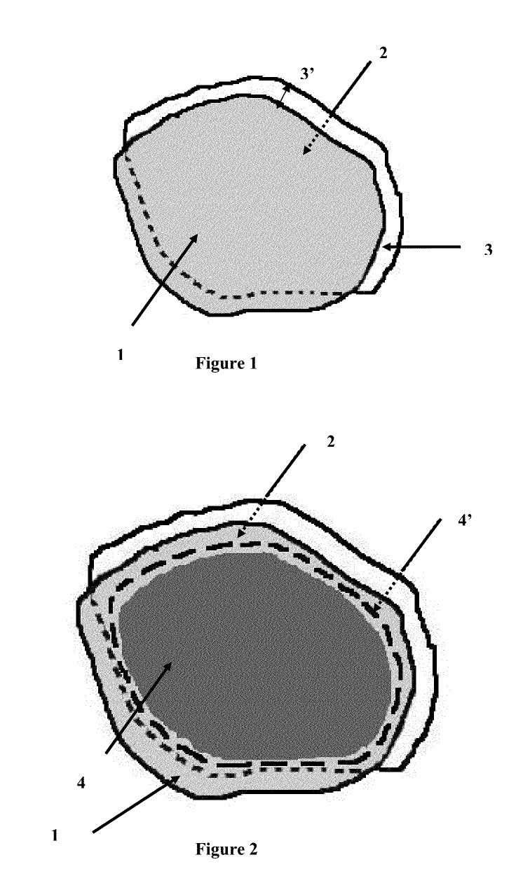

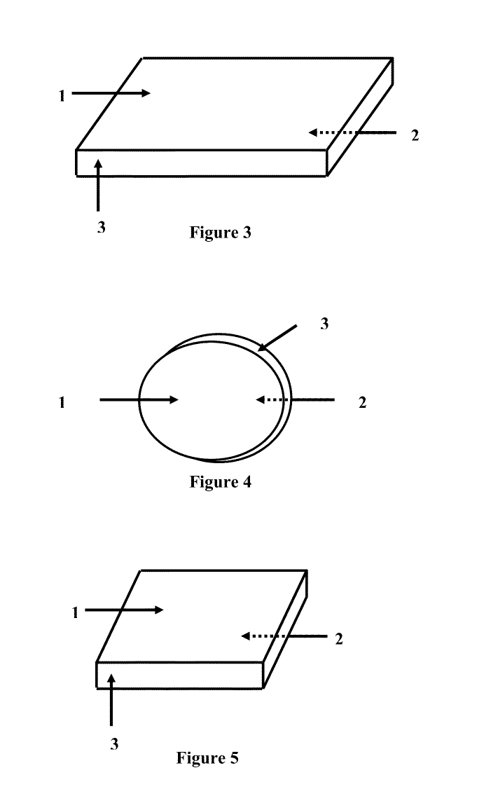

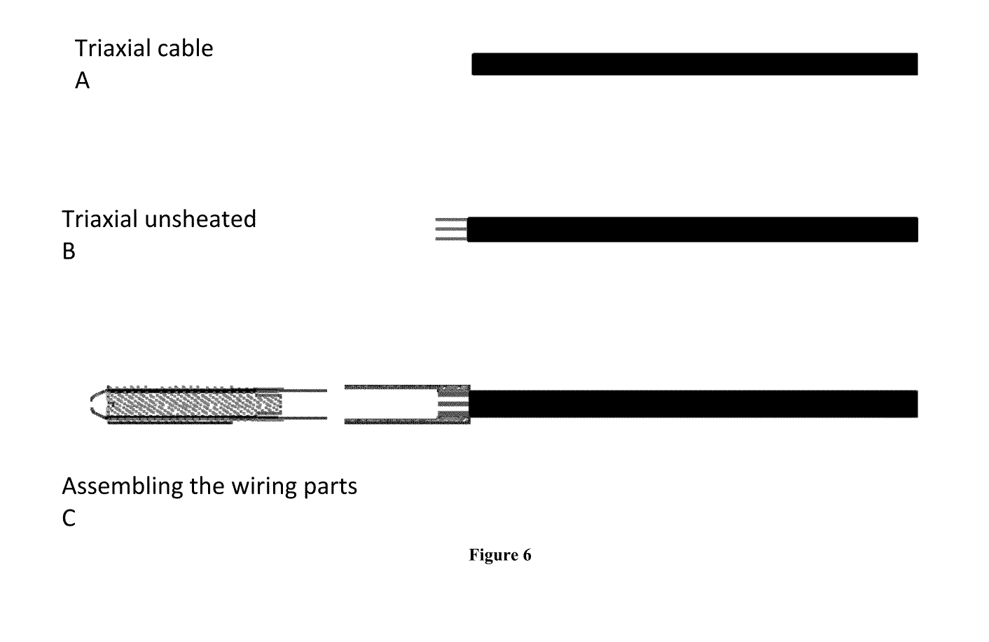

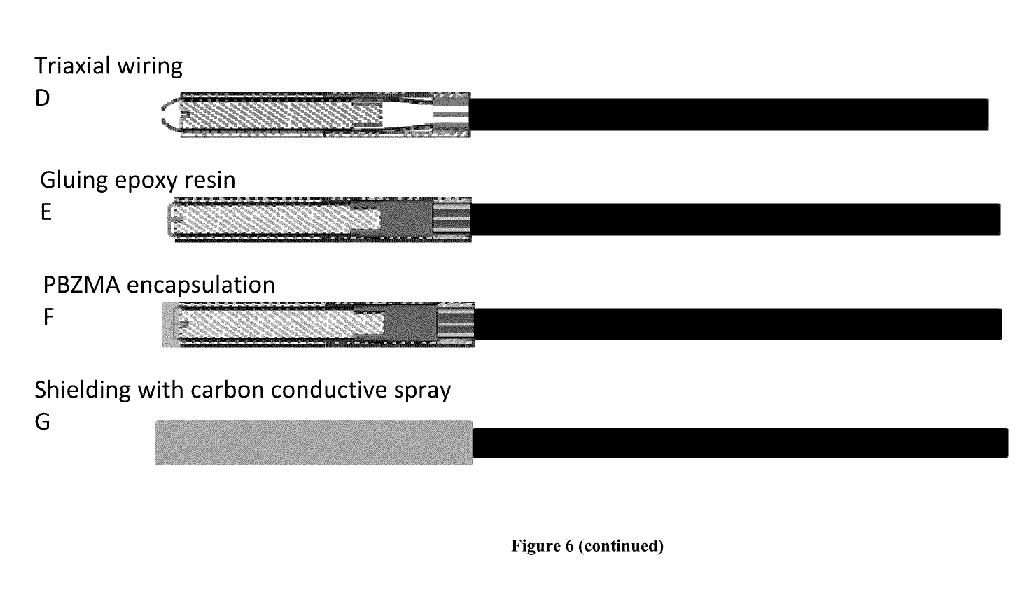

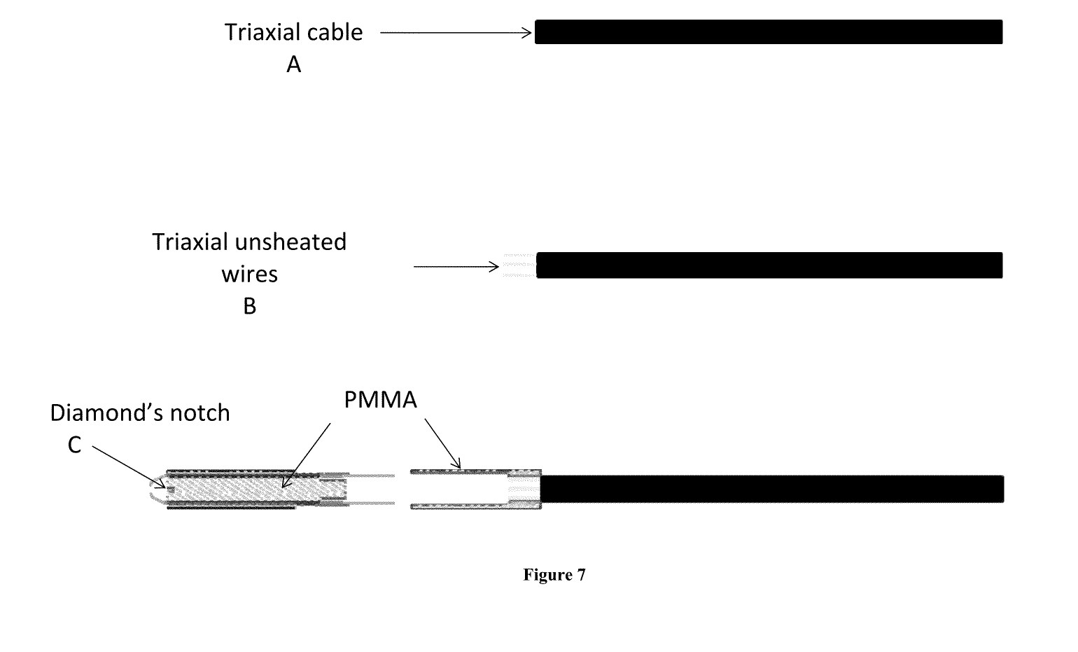

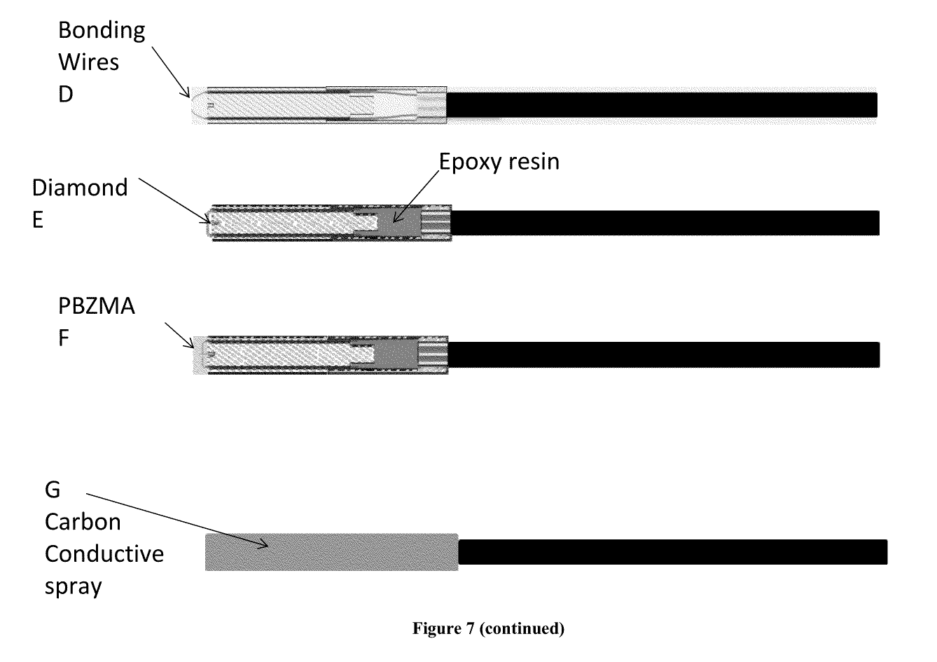

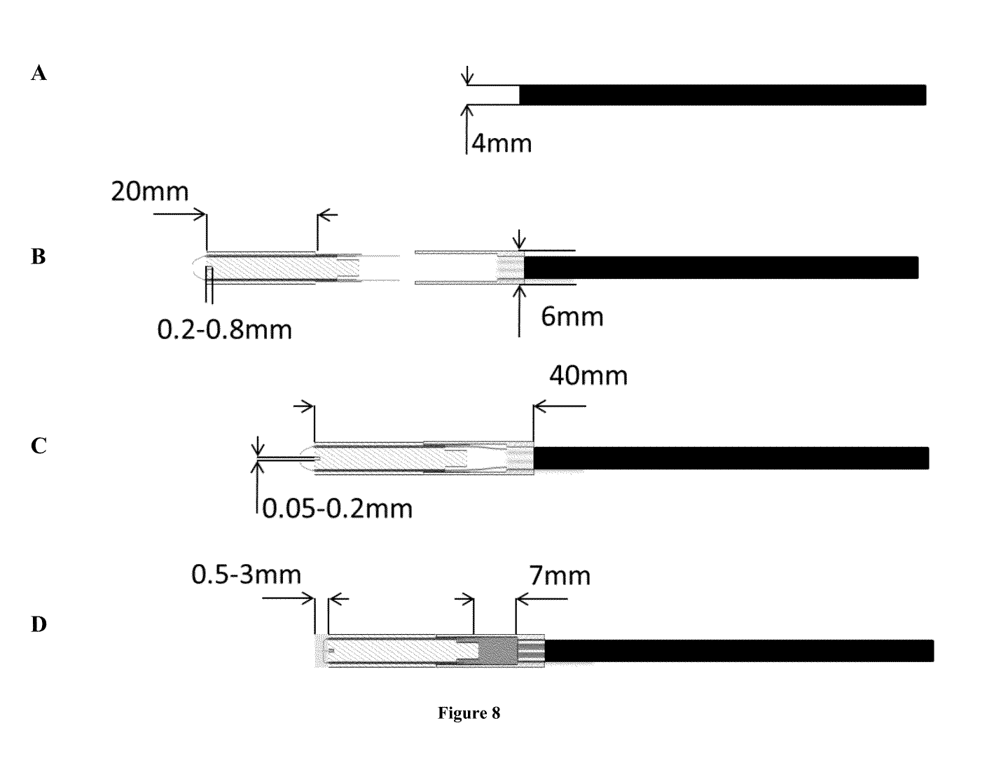

x-axis: field size (mm)

y-axis: Output factor

### EXAMPLES

### Example 1

### General Preparation of the Single Crystal Diamond Dosimeter of the Invention (SCDDo)

A synthetic diamond (mono crystalline diamond) presenting an epitaxial layer on a diamond substrate is cut by laser and its two sides are polished in order to optimize its lateral and longitudinal dimensions compared with its thickness to have a ratio signal to noise equal to 1000. The cut diamond is further chemically washed in a warm acid bath (KNO₃/H₂SO₄).

The washing step is crucial to obtain a clean surface on which the sets of electrode could be deposited.

On the diamond, the sets of electrode, the material of which presents a low Z, are deposited (carbon selected from the group consisting of amorphous carbon or non-organized carbon, Diamond Like Carbon (DLC), conductive diamond (P-type doping, N-type doping, implanted diamond or diamond with defects), graphite, non-organized graphite, amorphous carbon nitrite (aCNx), glassy carbon, conductive carbon ink, conductive polymer or a metal selected from the group consisting of Al, Cr—Au, Ti, C, Si, Ti, Cr, Ni, Ag, or a compound as ITO) with a thickness up to 1 μm.

Processes of deposit are well known from a man skilled in the art and can be for instance evaporation with an electron gun or physical vapor deposition (PVD) or thermal evaporation.

The voltage-current characteristic under irradiation of the detector allows verifying that the sets of electrode are operational by checking that there is near 100% of charge collection efficiency in at least one direction of polarization of the material. Said characteristic can be carried out by means of a lab X-ray tube for high, medium or low energies of X rays.

The diamond is then mounted on a support, the materials of which are chosen to be the closest to the tissue equivalence.

Diamond is inserted in a polymethylmethacrylate (PMMA) shape, presenting a hole liable to receive said diamond, in particular a PMMA cylinder, the maximal diameter of which is 6 mm and into which are introduced aluminium wires, the diameter of which is lower than or equal to 100 μm or any else material the Z of which is low, close to the tissue equivalence. Aluminium wires are connected to the triaxial cable according to the following scheme:

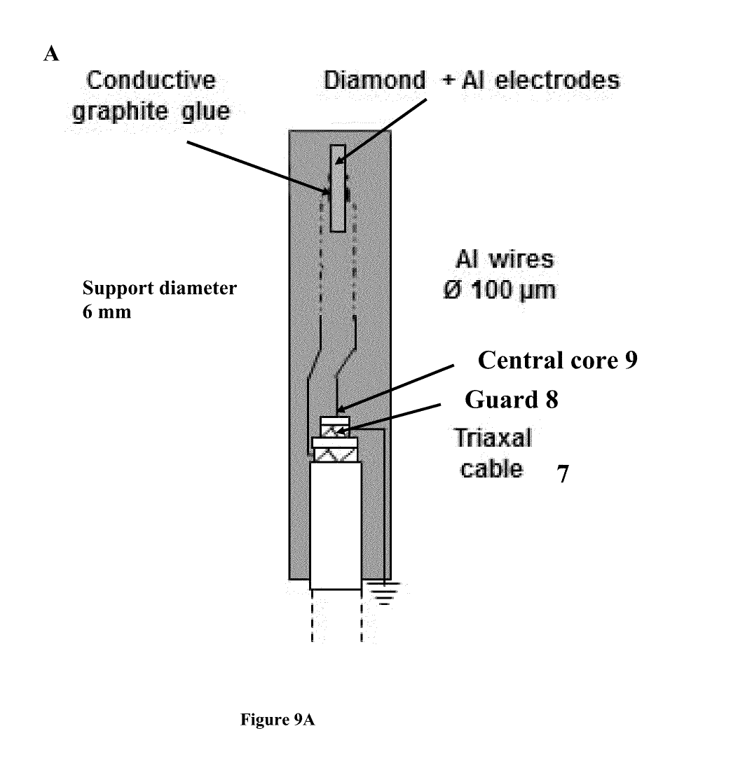

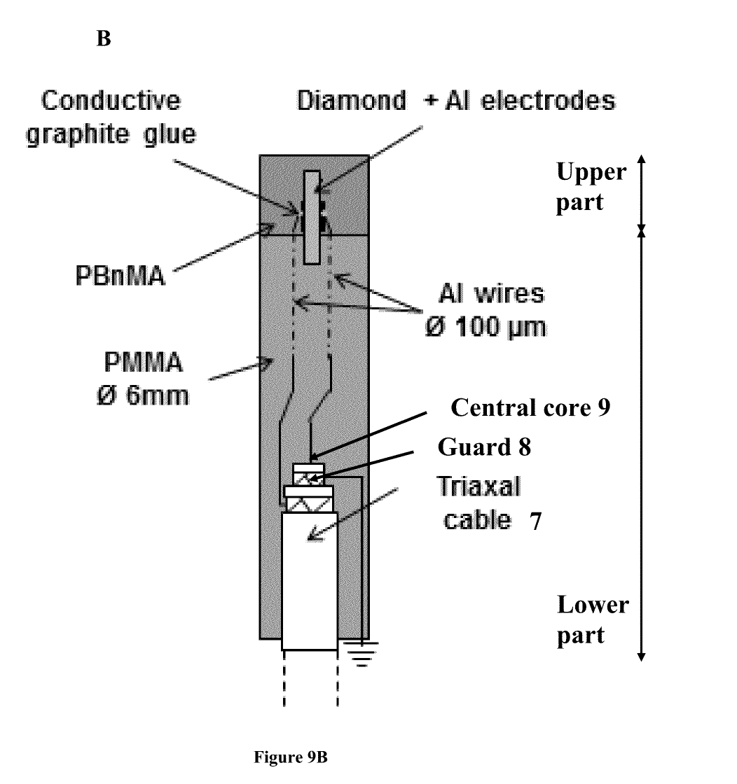

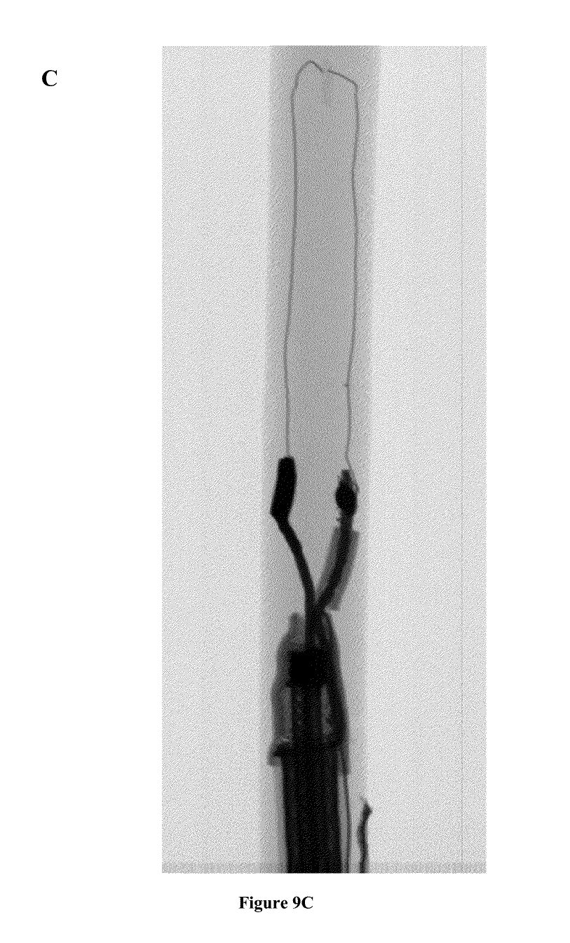

One of the wires is connected to the central core (9), the other one is connected to the external mass of the triaxial cable (FIG. 9A).

The guard (8) is not connected to diamond but is brought back on the PMMA support to give an external shielding (FIG. 9A). The diamond is mounted in the longest axis of the cylinder such as the example of FIG. 9A. The upper part of the aluminium wires are then connected to the surface of the sets of electrode of the diamond with a glue, such as graphite conductive glue, or a graphite charged epoxy resin. The connecting point with the connecting means must not cover the diamond and thus its acceptable maximal size covers the set of electrode.

The upper diameter of the cylinder of PbzMA around the diamond is comprised from about 2 to about 6 mm. The diamond is located at about 0.5 mm to about 1.6 mm, in particular at about 0.5 mm to about 1 mm, from the top of the upper part of the dosimeter.

The triaxial cable is connected at a distance comprised from 1 cm to more than 3 cm, in particular between 3 and 4 cm of the diamond to avoid a trouble in the measured dose. Optionally, a final electric isolation with a graphite colloid is carried out all around the dosimeter by connecting the guard of the triaxial cable to the external support of PMMA with this isolation. The isolation can be constituted of a graphite colloid, a lacquer, a paint or a graphite epoxy resin.

### Example 2

### Specific Single Crystal Diamond Dosimeter of the Invention (SCDDo) and Commercial Detectors

The Element Six electronic grade synthetic single crystal diamond of example 1 was used to develop water-equivalent SCDDo (FIG. 9A). The sample dimensions were 1 mm×1 mm×165 μm. 100 nm-thick aluminum sets of electrode were deposited on both sides of the diamond, using an evaporation system. The mounted detector exhibits a small detection volume of about 0.165 mm³, as required for small beam dosimetry. Materials present in this device were optimized in order to respect the low-Z requirements for small beam dosimetry and to obtain almost a water-equivalent detector: aluminum sets of electrode, aluminum wires of 100 μm in diameter, conductive graphite glue, Polybenzylmethacrylat (PBnMA) and Polymethylmethacrylat (PMMA) encapsulation. The triaxial cable was connected at a distance larger than 3 cm in order to avoid perturbation of the deposited dose in the diamond.

Finally, conductive colloid graphite covered the device and was connected to ground in order to reduce environmental noise. The position of detection volume in the water-equivalent housing was verified with X-rays radiography. The diamond was located 1.6 mm below the top surface of the housing.

The comparison between the SCDDo (named in figures SCDDo example 2) and different commercial detectors was performed within this work. The unshielded 60017 diode (PTW, Freiburg, Germany) is a p-type silicon diode, operating at 0 V, with a disk-shaped sensitive volume perpendicular to the detector axis. Its detection volume has dimensions of 0.6 mm in diameter and 30 μm in thickness. The reference point is located on detector axis, 0.77 mm from detector tip.

A good performance of this new unshielded diode and its previous model (PTW 60012) has been observed by many authors in small beam measurements (Y. Dzierma, N. Licht, F. Nuesken, C. Ruebe, [symbol] Beam properties and stability of a flattening-filter free 7 MV beam—An overview. [symbol] , Med. Phys., vol. 39, p. 2595-2602, 2012; I. Griessbach, M. Lapp, J. Bohsung, G. Gademann, D. Harder, [symbol] Dosimetric characteristics of a new unshielded silicon diode and its application in clinical photon and electron beams [symbol] , Med. Phys. vol. 32, p. 3750-3754, 2005; C. Scherf, C. Peter, J. Moog, J. Licher, E. Kara, K. Zink, C. Rodel, U. Ramm, [symbol] Silicon diodes as an alternative to diamond detectors for depth dose curves and profile measurements of photon and electron radiation. [symbol] , Strahlenther Onkol, vol. 185, p. 530-536, 2009).

The PTW 31014 PinPoint ionization chamber (marketed by PTW) is a miniaturized ionization chamber commercially available for small beam and is known as a good reference detector for beam sizes from 3×3 cm² to 10×10 cm² (A. J. D. Scott, A. E. Nahum, et J. D. Fenwick, [symbol] Using a Monte Carlo model to predict dosimetric properties of small radiotherapy photon fields [symbol] , Med Phys, vol. 35, no. 10, p. 4671-4684, October 2008; W. U. Laub et T. Wong, [symbol] The volume effect of detectors in the dosimetry of small fields used in IMRT [symbol] , Med Phys, vol. 30, no. 3, p. 341-347, mars 2003; C. Martens, C. De Wagter, et W. De Neve, [symbol] The value of the PinPoint ion chamber for characterization of small field segments used in intensity-modulated radiotherapy [symbol] , Phys Med Biol, vol. 45, no. 9, p. 2519-2530, September 2000).

It operates at the nominal voltage of 400 V and exhibits a large volume of 15 mm³ (2 mm diameter by 5 mm length).

The PTW natural diamond detector was polarized at +100 V and its sensitive volume dimensions range from 1 to 6 mm³. Its active volume is located on detector axis, 1 mm below the top surface of the housing.

### Example 3

### Radiation Beams and Experimental Setup

Clinical environment measurements were performed with the SCDDo at La Pitié Salpêtriëre Hospital (Paris, France), under photon beams produced by a Varian Clinac 2100 C medical linear accelerator (marketed by Varian). A micro multileaf collimator system (μMLC m3, BrainLab) dedicated to stereotactic treatments was attached to this accelerator. Measurements were performed in a PTW MP3 motorized water phantom (marketed by PTW), at a source-surface distance (SSD) of 100 cm. The SCDDo was positioned in the water tank with its cable parallel to the beam axis and the smallest dimension of the diamond detection volume (its thickness of 165 μm) in cross-plane direction. All measurements were performed with a 6 MV photon beam, except for the study of energy dependence.

Current-voltage characteristic (I-V), repeatability and dose linearity of the SCDDo response were studied with a dose rate of 400 MU·min⁻¹, at 10 cm-depth in water, for a 10×10 cm² field. In these conditions, the absolute dose determined with a calibrated PTW 31003 ionization chamber was 0.6605 cGy·MU⁻¹. Current-voltage characteristic of the device was examined in order to determine the optimal operating voltage for a maximum charge collection. I-V curve was measured for bias voltages ranging from 0 V to 100 V, in 10 V steps, using a remotely controlled Keithley 6517A electrometer. The repeatability was studied with ten consecutive irradiations with a constant dose of 100 MU and by determining the coefficient of variation (the percentage ratio of standard deviation to mean charge). The dose dependence of the SCDDo response was measured by irradiating the detector with a dose range from 10 to 800 MU.

The dose rate dependence of the detector response was then investigated by varying both dose per pulse and pulse repetition frequency, for a 10×10 cm² field, at 10 cm-depth in water. The first method consists of changing the SSD from 107 cm to 83 cm. The dose rate measured with the reference chamber was varied from 2.34 to 3.64 Gy/min. Measurements were performed by irradiating the SCDDo at each SSD with a constant dose of 1 Gy.

To expand the dose rate range, the second method consists of changing the pulse repetition frequency from 80 MU·min⁻¹ to 400 MU·min⁻¹, corresponding to a dose rate variation from 0.53 to 2.64 Gy·min⁻¹. Measurements were performed by irradiating the SCDDo at each pulse repetition frequency with a constant dose of 1.32 Gy.

The energy dependence of the detector response was studied by irradiating the SCDDo with a dose of 0.66 Gy, in a 10×10 cm² field, at 10 cm-depth in water, for the beam qualities available on the accelerator: 6MV and 18 MV photon beams.

Repeatability, dose linearity, dose rate and energy dependence of the detector were studied by connecting the SCDDo to a PTW UNIDOS electrometer commonly used in dosimetry. Lateral dose profiles and depth dose curves were measured with the SCDDo for the smallest field size available with the μMLC m3 (0.6×0.6 cm²) and for the 10×10 cm² reference field. The dose profiles measured at 10 cm-depth in water were compared to those obtained with three commercially available detectors: the silicon diode providing a good spatial resolution (PTW 60017), the PTW 31014 PinPoint ionization chamber and a PTW natural diamond detector for which the precise active volume is unknown. Dose profiles were normalized at 100 percent on beam axis and the 20%-80% penumbras were evaluated for all detectors. The depth dose curves measured with the SCDDo for 0.6×0.6 cm² and 10×10 cm² field sizes were compared to those obtained with the PTW 60017 silicon diode and the PinPoint chamber. Depth dose curves were normalized at the depth of maximum dose (dₘₐₓ). The entrance surface dose (De), the value of dₘₐₓ and the percentage depth dose (PDD) at 10 cm in water were analyzed for all detectors. For lateral dose profiles and depth dose curves measurements, all detectors were positioned vertically with the stem and cable aligned with the beam to ensure their uniform irradiation and they were connected to a PTW Tandem Dual Channel electrometer controlled by Mephysto software.

Output factor (OF) measurements were performed with the SCDDo and compared to the one obtained with the PTW 60003 diamond dosimeter, from 0.6×0.6 cm² to 10×10 cm² field sizes. The detectors were connected to a PTW UNIDOS electrometer and positioned vertically. Precise positioning of detector reference point on beam axis was performed by acquiring lateral dose profiles for 0.6×0.6 cm² field size, before OF measurements.

### Example 4

### Results and Discussion

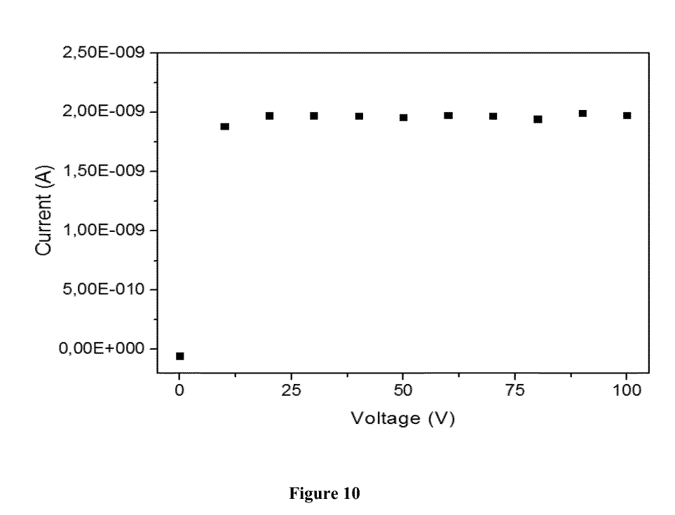

The preliminary I-V curve with 6 MV photon beam obtained for the SCDDo is shown in FIG. 10 from 0 V to 100 V. The diamond detector signal saturates for bias voltage higher than 20V at a current value of 1.95 nA. This saturated current (I_{R}) was compared to the theoretical current value I_{P} described by the following equation (P. W. Hoban, M. Heydarian, W. A. Beckham, et A. H. Beddoe, [symbol] Dose rate dependence of a PTW diamond detector in the dosimetry of a 6 MV photon beam [symbol] , Phys Med Biol, vol. 39, no. 8, p. 1219-1229, août 1994; F. Schirru, K. Kisielewicz, T. Nowak, et B. Marczewska, [symbol] Single crystal diamond detector for radiotherapy [symbol] , Journal of Physics D: Applied Physics, vol. 43, no. 26, p. 265101, juill. 2010):

$${I}_{P} = \frac{D ρ eV}{ω}$$

The ratio G=I_{R}/I_{P} is defined as the gain factor or the charge collection efficiency. Assuming a dose rate D=2.64 Gy·min⁻¹ (measured with the calibrated ionization chamber), the density of diamond p=3.51 g·cm³, the electronic charge e=1.6·10⁻¹⁹ C, the SCDDo sensitive volume V=1.65·10⁻⁴ cm³ and the energy required to create an electron-hole pair in diamond w=13 eV, we obtain I_{P}=1.96 nA. This confirms the 100% charge collection efficiency at bias voltage higher than 20 V, due to the high quality of diamond material and electrical contacts.

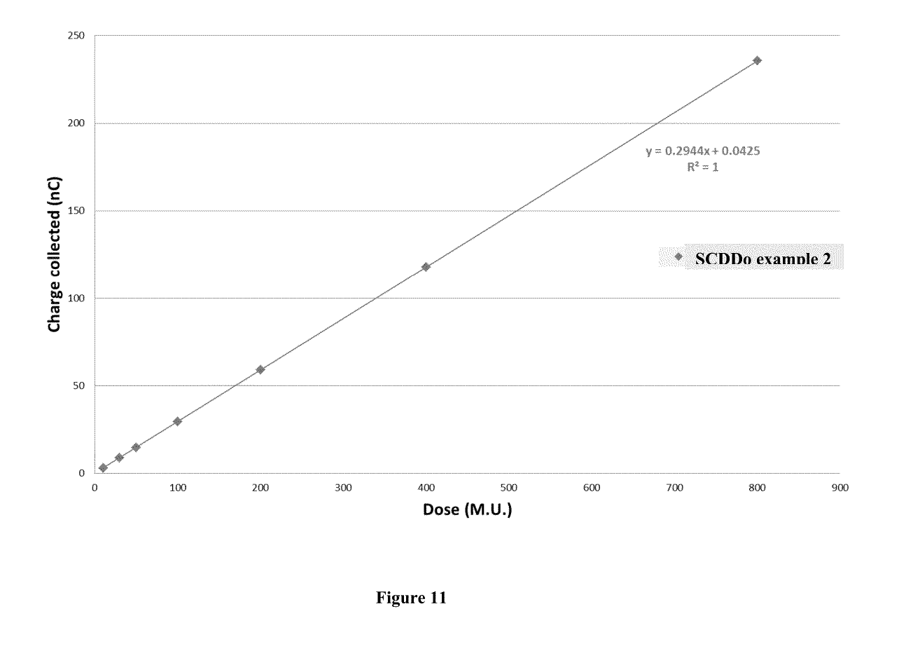

The following studies were performed with a bias voltage of 50 V. After a pre-irradiation of 5 Gy, the coefficient of variation determined for 10 consecutive irradiations of the SCDDo with a constant dose of 0.66 Gy was 0.06% and confirmed the excellent repeatability of the SCDDo response. A sensitivity of 44.5 nC·Gy⁻¹ was deduced from these measurements. The dose linearity of the SCDDo response was verified for a 10×10 cm² field size, by irradiating the detector with a dose range from 10 to 800 MU. Dose linearity was observed with a linearity coefficient R² equal to 1 (FIG. 11).

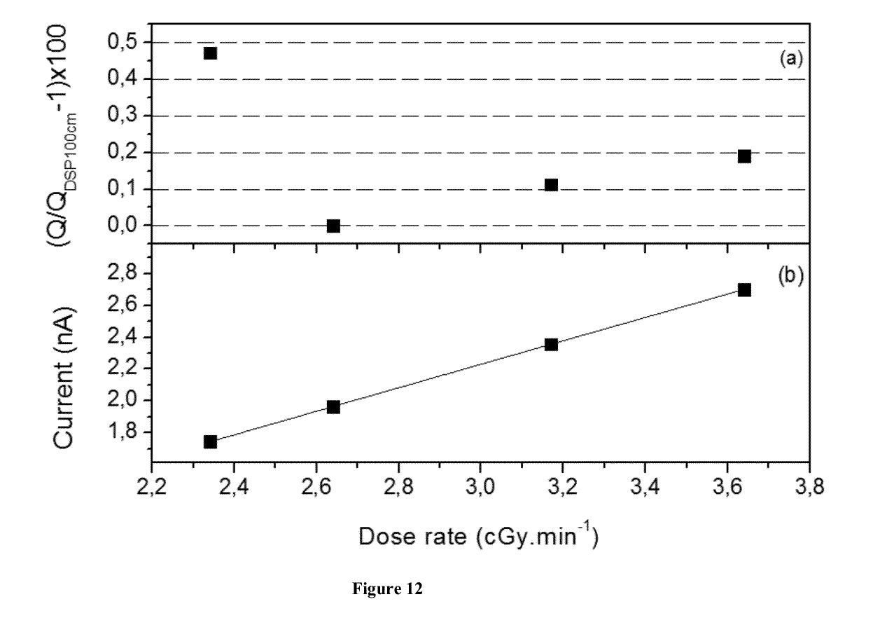

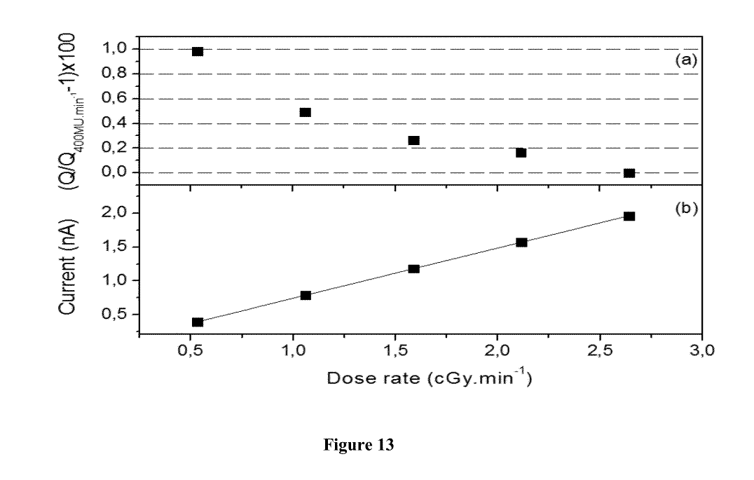

The dose rate dependence of the SCDDo response is shown in FIG. 12 and Figure FIG. 13. The percentage deviation of the measured charge with respect to the one measured at SSD 100 cm and 400 MU·min⁻¹ is reported in FIG. 12.a and FIG. 13.a. A deviation lower than 0.5% is observed in the dose rate range investigated by changing the dose per pulse (dose rate from 2.34 to 3.64 Gy·min⁻¹), and a maximum deviation of 1% is obtained by changing the pulse repetition frequency (dose rate from 0.53 to 2.64 Gy·min⁻¹).

The SCDDo behavior with dose rate was also analyzed with the Fowler's model (J. F. Fowler, Radiation dosimetry, in: F. H. Attix, W. C. Roesch (Eds.), Academic, New York, 1966) described by the following equation:

I=I₀+R·D^{Δ}

where I is the SCDDo current, I₀ the dark current and A the fitting parameter that describes the deviation to linearity. This last parameter has to be as close as possible to 1 to have a detector response linear according to the dose rate FIG. 12.b. and FIG. 13.b. show the SCDDo current as a function of dose rate and the corresponding fitting curve according to Fowler's equation, respectively for dose per pulse variations and pulse repetition frequency changes; the results of the fitting give a Δ value of 0.977±0.017 and 0.997±0.005 respectively. These results are in good agreement with those obtained with natural diamond of PTW dosimeter (P. W. Hoban, M. Heydarian, W. A. Beckham, et A. H. Beddoe, [symbol] Dose rate dependence of a PTW diamond detector in the dosimetry of a 6 MV photon beam [symbol] , Phys Med Biol, vol. 39, no. 8, p. 1219-1229, août 1994; C. D. Angelis, S. Onori, M. Pacilio, G. A. P. Cirrone, G. Cuttone, L. Raffaele, M. Bucciolini, S. Mazzocchi. [symbol] An investigation of the operating characteristics of two PTW diamond detectors in photon and electron beams. [symbol] , Med. Phys., vol. 29, p. 248-254, 2002) and with other synthetic single crystal diamonds (F. Schirru, K. Kisielewicz, T. Nowak, et B. Marczewska, [symbol] Single crystal diamond detector for radiotherapy [symbol] , Journal of Physics D: Applied Physics, vol. 43, no. 26, p. 265101, juill. 2010; D. Tromson, C. Descamps, N. Tranchant, P. Bergonzo, M. Nesladek, A. Isambert, [symbol] Investigations of high mobility single crystal chemical vapor deposition diamond for radiotherapy photon beam monitoring [symbol] , J. Appl. Phys. 103 (2008) 54512-54516) and confirm the low dose rate dependance of the SCDDo. Thus, the depth dose curve measured with the SCDDo will not require correction factor for the dose rate.

The energy dependence of the detector response was determined for 6MV and 18 MV photon beams, in a 10×10 cm² field, at 10 cm-depth in water. The SCDDo current was measured for a constant dose of 0.66 Gy, for both beam qualities. The variation of the diamond response was only about 1.2%.

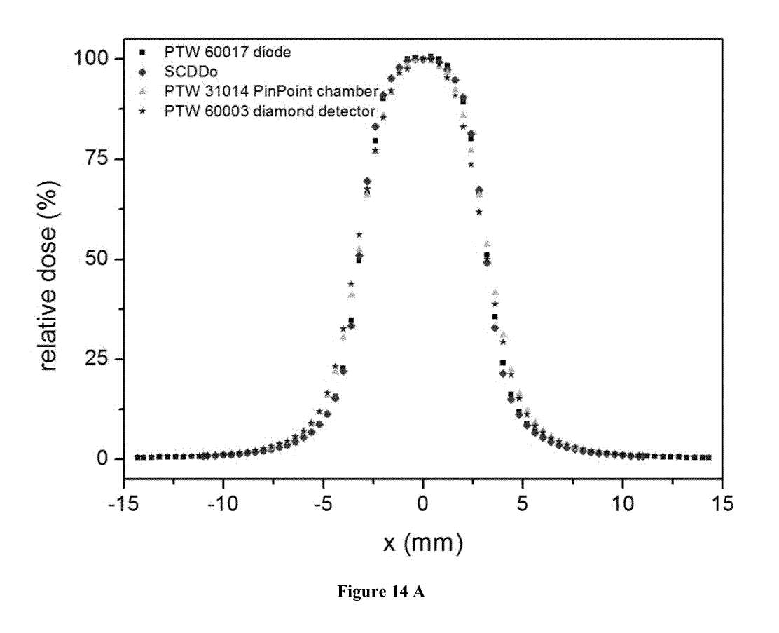

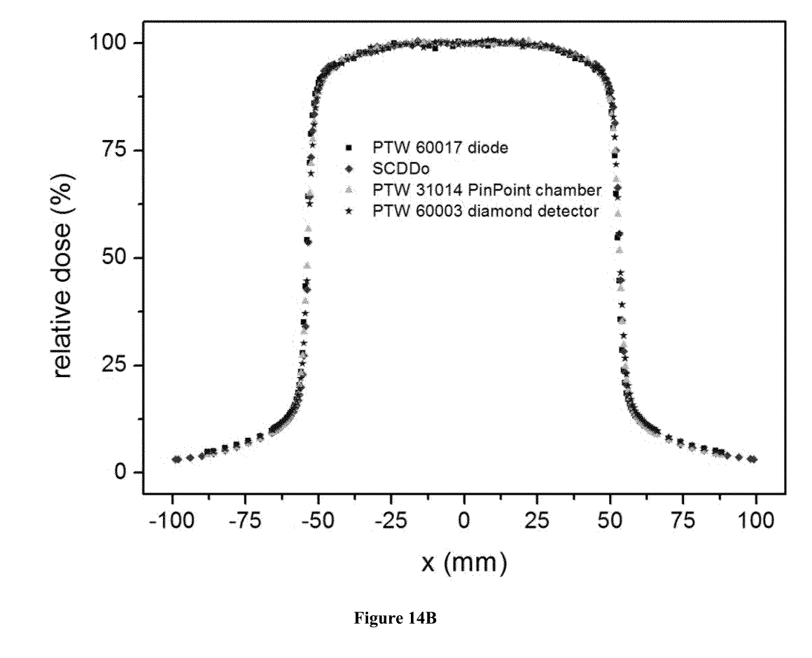

The cross-plane dose profiles measured with the SCDDo and three commercially available detectors are displayed in FIGS. 14A and 14B, for a 0.6×0.6 cm² and a 10×10 cm² field. The 20%-80% penumbras are reported in Table II for cross-plane and in-plane dose profiles. The SCDDo penumbras are slightly better than those obtained with the PTW 60017 diode which is considered as an excellent spatially resolved commercial detector for small beams. The SCDDo penumbras are much better than those measured with the PTW 31014 ionization chamber and the PTW 60003 diamond detector because of the volume averaging effect. Table II confirms also the best spatial resolution of the SCDDo in cross-plane direction compared to in-plane, due to its small thickness orientation. These penumbra values confirm the excellent spatial resolution of the SCDDo, thanks to its small detection volume.

TABLE II
20%-80% penumbras of dose profiles measured with the SCDDo, the
PTW 60017 diode, the PTW 31014 PinPoint chamber and a PTW
diamond detectorat 10 cm-depth in water, for a 6 MV photon beam and
two beam sizes: 0.6 × 0.6 cm² and 10 × 10 cm².

| | | | | | PTW 31014 | | PTW 60003 | |
|---|---|---|---|---|---|---|---|---|
| | | | PTW 60017 | | PinPoint | | diamond | |
| | SCDDo | | diode | | chamber | | detector | |
| | penumbra | | penumbra | | penumbra | | penumbra | |
| Field | (mm) | | (mm) | | (mm) | | (mm) | |
| size | In- | Cross- | In- | Cross- | In- | Cross- | In- | Cross- |
| (cm²) | plane | plane | plane | plane | plane | plane | plane | plane |
| 0.6 × | 1.87 | 1.64 | 1.96 | 1.79 | 2.39 | 2.28 | 2.48 | 2.34 |
| 0.6 | | | | | | | | |
| 10 × | 4.39 | 4.03 | 4.80 | 4.23 | 5.08 | 4.86 | 5.08 | 4.79 |
| 10 | | | | | | | | |

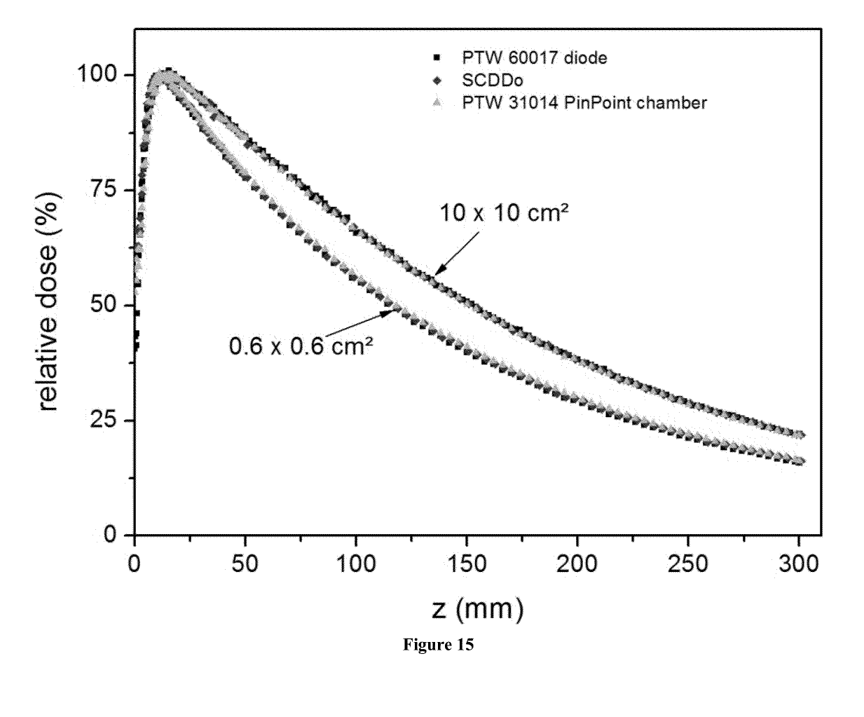

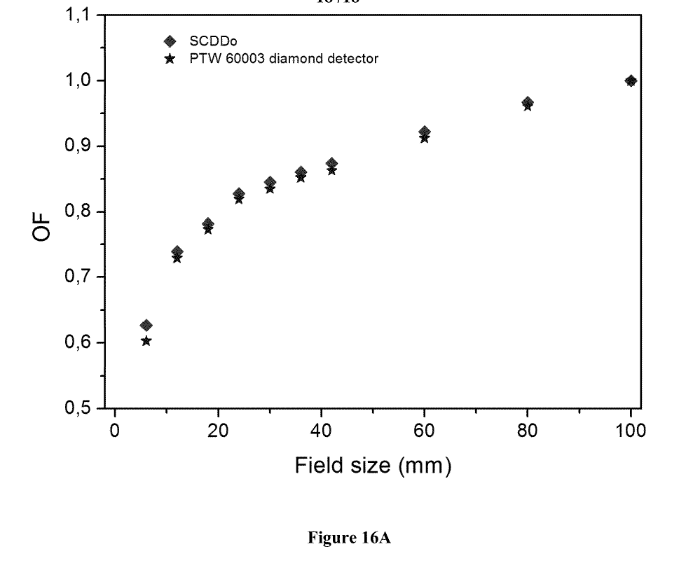

Depth dose profiles measured with the SCDDo, the unshielded silicon diode (PTW 60017) and the PinPoint ionization chamber (PTW 31014) are displayed in FIG. 15, for a 0.6×0.6 cm² and a 10×10 cm² field. The entrance surface dose (De), the depth of dose maximum (dₘₐₓ) and the percentage depth dose (PDD) at 10 cm are reported in Table III for both investigated field sizes.

All detectors are in good agreement for the 10×10 cm² reference field size, except for De values reported in Table III. Since the active volume is located at 0.77 mm and 1.6 mm below the top surface of the housing for the diode and for the SCDDo respectively, the SCDDo build up thickness is more important than the diode one and this explains the difference of entrance surface dose (De) for both detectors.

The entrance surface dose obtained with the PinPoint chamber is also higher than the diode one, because the PinPoint chamber was positioned with its cable parallel to beam axis and its active volume has a length of 5 mm in this orientation; the averaging effect influences the entrance surface dose and leads to larger uncertainties in depth dose curve measurements.

For the 0.6×0.6 cm² field size, a good agreement is observed between the SCDDo and the diode depth dose curves, except for the entrance surface dose values for the same reasons explained previously. For this small beam, PDD determined at 10 cm with the PinPoint chamber is higher than the SCDDo and diode one. The reason of this last result is the dose underestimation at dₘₐₓ with the PinPoint chamber, because its detection volume is too large compared to the beam size at this depth in water and because the presence of air in ionization chamber increases the loss of lateral electronic equilibrium, decreasing the dose measured on the beam axis. But at higher depth in water, the field size increases, the lateral electronic disequilibrium decreases, and the dose measured with the PinPoint chamber is getting closer to the expected value. Since the depth dose curve is normalized at dₘₐₓ, PDD at higher depth is slightly overestimated with this ionization chamber.

TABLE III
Depth of maximum dose (dₘₐₓ) and percentage depth dose (PDD) at 10 cm-
depth in water measured with the SCDDo of example 2, the PTW 60017 diode and
the PTW 31014 PinPoint chamber, for a 6 MV photon beam and two beam sizes.

| | | | | | | | PTW 31014 PinPoint | | |
|---|---|---|---|---|---|---|---|---|---|
| Field | SCDDo | | | PTW 60017 Diode | | | chamber | | |
| size | | PDD | | | PDD at | | | PDD at | |
| (cm²) | dₘₐₓ | at 10 cm | De | dₘₐₓ | 10 cm | De | dₘₐₓ | 10 cm | De |
| 0.6 × 0.6 | 11.4 mm | 55.8% | 66.3% | 11.3 mm | 55.3% | 41.3% | 11.7 mm | 56.3% | 57.7% |
| 10 × 10 | 13.9 mm | 66.6% | 62.7% | 14.0 mm | 66.4% | 43.2% | 15.0 mm | 66.3% | 52.8% |

OFs normalized at the 10×10 cm² field, measured with the SCDDo of example 2 and a PTW 600030 diamond detector are displayed in FIG. 16A. Concerning the comparison between PTW diamond detector and SCDDo, since the PTW diamond detector active volume is larger than the one of SCDDo of Example 2 (0.15 mm³), OFs measured with PTW diamond detector is lower than those obtained with the SCDDo of example 2, with a maximum deviation of 3.8%. These results clearly show a significant improvement of the OF measurement with the SCDDo compare to those obtained with a commercial PTW diamond dosimeter.

### Conclusion

Water-equivalent diamond dosimeter has been developed using a commercially available single crystal from Element Six Ltd. Clinical environment measurements have been performed to evaluate the suitability of the device for small beam dosimetry. The detector was polarized at 50 V to have a maximum charge collection.

A high sensitivity of 44.5 nC·Gy′ has been obtained by applying this bias voltage to the SCDDo. An excellent repeatability (0.06%) has been observed with this device. The dose linearity of the SCDDo response has been verified with 6 MV photon beam, for a large dose range. A low dose rate dependence of the SCDDo response (less than 1%) with Fowler Δ values close to 1 has been observed, by changing the dose per pulse or the pulse repetition frequency. Finally, a low energy dependence of 1.2% of the diamond response was observed between 6 MV and 18 MV beam quality.

Lateral dose profiles measured with the SCDDo for the smallest field size available with the μMLC-m3 (0.6 cm×0.6 cm) and for the 10×10 cm² reference field size present an excellent spatial resolution due its small detection volume (0.15 mm³). The 20%-80% penumbras measured with the SCDDo are smaller than those measured with the excellent spatially resolved PTW 60017 diode, PTW 31014 PinPoint chamber and PTW 60003 diamond detectors. Depth dose curves measured with the SCDDo are in good agreement to those obtained with the PTW 60017 diode and the PTW 31014 PinPoint chamber for a 10×10 cm² field size.

For the smallest field size (0.6×0.6 cm²), the diode and SCDDo depth dose curves are in good agreement. The PinPoint PDDs are slightly higher than those obtained with the other detectors due to its large detection volume of air.

Output factors measured with the SCDDo for field sizes smaller than 1.8×1.8 cm² are compared to those measured with PTW 60003 diamond dosimeter. Results show a clear improvement with SCDDo from example 2.

### Example 5

### Modifications of the Electrode Materials

The SCDDo of example 2 have been modified with various electrodes materials. Materials of the sets of electrode with atomic number as close as possible to tissue equivalence with thickness around 100 nanometers have been tested.

Materials with atomic number as close as possible to tissue equivalence with thickness around 100 nanometers have been tested. Conductive amorphous carbon or non-organized carbon, Diamond Like Carbon (DLC), conductive diamond (P-type doping, N-type doping, implanted diamond or diamond with defects), graphite, non-organized graphite, amorphous carbon nitrite (aCNx), glassy carbon, conductive carbon ink, conductive polymer and also Indium tin oxide have been tested in the same configuration than aluminum contact presented in previous part. Results excepted for OF measurements are not significantly changed because the atomic number of the sets of electrode tested is low. The most important thing is to have 100% of charge collected.

### Example 6

### Modification of the Encapsulation

The SCDDo of example 2 have been modified:
various diameter of encapsulation materials have been tested, and/or
the upper part of the support has been modified, and/or
the location of the diamond inside the encapsulation material has been varied.

The external encapsulated material diameter has been changed from 6 to 4 mm by 1 mm step. The modification has been done only on the part with the encapsulated diamond and then on the global device.

Further the upper part of the support has been reduced to be as close as possible to the diamond size in order to minimize the influence on the Depth dose profile.

The diamond active volume presently located at 1.6 mm below the top surface of the housing has been located at 500 microns by reduction of the build-up thickness, consequently the measurement of the entrance surface dose has been improved.

Consequently, for different diamond size, the upper part of the support has been reduced to be as close as possible to the diamond size in order to minimize the influence on the Depth dose profile.

### Example 7

### Modification of the Geometry of the Set of Electrode

The geometry of the sets of electrode of the SCDDo of example 2 has been modified to provide another comparative example.

The geometry of the sets of electrodes has been changed from complete diamond surface covering to circular shape. Typically for a 2 mm×2 mm×150 microns thick with a 1 mm circular shape set of electrode has been tested. Diamond bias influence measurements in hospital is performed and have been compared to those obtained with complete diamond surface covering sets of electrode. Non saturated I(V) curve have already been measured that implies difficulties to performed measurement.

Further, geometry with an extra-large and thick diamond (4 mm×4 mm×500 μm), a fitted thick diamond (1 mm×1 mm×500 microns) and a large thin diamond (2 mm×2 mm×150 μm) all with a 1 mm set of electrode have been tested. SCDDo could be bias in order to gain 100% of charge collection efficiency. These, measurements in hospital are in progress to demonstrate that the SCDDo of example 2 is inventive by combining a completely covering electrode and a thin diamond thickness. In the case of a too important thickness, the OF factor measurement will be shifted. In the case of a nearly not covering electrode surface, a dose rate and detector bias dependencies are observed.

### Example 8

### Modification of the Diamond Surface

The SCDDo diamond surfaces of the example 2 have been modified prior to realize the deposition of the sets of electrode.

First a diamond surface oxidation (to obtain a non-conductive diamond surface) with chemical treatment as well as ozonized treatment has been carried out and then the sets of electrode have been deposited on the complete diamond surface. Diamond surface hydrogenation (in order to have diamond conductive surface layer) has also been performed on the total surface and on both faces prior the deposition of the sets of electrode.

Further, different techniques to deposit the sets of electrode have been performed with particular attention on the effect of the diamond-set of electrode interface. This interface can be tune by testing various deposition recipe and also various deposition technique such as PVD, e-beam, . . . .

1. Diamond dosimeter, in particular diamond waterproof dosimeter, comprising a detector constituted by:
a single crystal diamond presenting two parallel planar sides (1, 2) and an edge (3), said two planar sides being spaced by a thickness (3′) corresponding to the height of the edge, and exhibiting a volume of crystal from about 0.06 mm³ to about 0.27 mm³,
two sets of electrode (4, 4′), each of them being deposited on each side (1, 2) of the single crystal diamond, wherein each set of electrode covers independently from each other at least 75% of the surface of said side,
wherein the sensitive volume is from about 0.06 mm³ to about 0.2 mm³,
wherein the edge (3) of the single crystal diamond is substantially devoid of electrode material and wherein the sets of electrode are not surrounded by a guard ring.

2. Diamond dosimeter according to claim 1,
wherein said two planar sides are identical.

3. Diamond dosimeter according to claim 1, wherein said two planar sides present a surface of about 0.30 mm² to about 1 mm², in particular 1 mm².

4. Diamond dosimeter according to claim 3,
wherein said two planar sides present a surface of about 1 mm² and are spaced by a thickness comprised from 60 μm to about 200 μm, in particular from about 88 to about 200 μm, in particular from 100 μm to about 165 μm, more particularly 165 μm.

5. Diamond dosimeter according to, wherein each set of electrode covers substantially 100% of each planar side and in particular wherein said two parallel planar sides are rectangular, circular or square.

6. Diamond dosimeter according to claim 1 wherein the material of said sets of electrode has a Z of about 5 to about 28, in particular wherein each set of electrode presents a thickness from about 0.01 μm to about 100 μm, preferably of about 0.01 μm to about 10 μm, more preferably of about 0.01 μm to about 0.5 μm, in particular about 0.1 μm.

7. Diamond dosimeter according to claim 1, wherein the material of said sets of electrode is carbon selected from the group consisting of conductive amorphous carbon or non-organized carbon, Diamond Like Carbon (DLC), conductive diamond (P-type doping, N-type doping, implanted diamond or diamond with defects), graphite, or the material of said sets of electrode is a metal selected from the group consisting of Al, C, Si, Cr, Ni, Ti, in particular Al.

8. Diamond dosimeter according to claim 1 wherein the material of said sets of electrode has a Z higher than 28, in particular Ag, Au or Pt, in particular wherein each set of electrode presents a thickness from about 0.01 μm to about 1 μm, preferably of about 0.02 μm to about 1 μm, in particular about 0.2 μm, in particular said sets of electrode are constituted of a stacking up of electrodes, in particular Ti/Au with a respective thickness of each stacking up of about 2 nm and about 50 nm or a Ti/Pt/Au stacking a with respective thickness of each stacking up of 5-10 nm, 50 nm and 500 nm.

9. Diamond dosimeter according to claim 1, comprising two conductive wires (5, 5′) connecting the sets of electrode to a triaxial cable (6), itself possibly comprising a central core (7) and guard (8).

10. Diamond dosimeter according to claim 9, wherein the material of said two conductive wires is aluminium, silicon, carbon, nickel, and their alloy, in particular wherein the conductive wires have a thickness of less than 100 μm, in particular comprised from about 20 μm to about 100 μm.

11. Diamond dosimeter according to claim 9, wherein said two conductive wires are connected to said crystal diamond by connecting means chosen among conductive glue, in particular selected form the group consisting of graphite or a graphite charged epoxy resin, carbon charged epoxy resin, carbon conductive paste or by bonding, in particular wherein one of said wires is connected on its upper extremity to one set of electrode of said single crystal diamond and on its lower extremity to said triaxal cable and the second wire is connected on its upper extremity to the second set of electrode of said single crystal diamond and on its lower extremity to said central core of said triaxal cable and in particular further comprising a support in which said single crystal diamond is mounted, in particular the parallel planar sides of said crystal diamond are square.

12. Diamond dosimeter according to claim 11, wherein said support is constituted of two parts,
an upper part comprising the single crystal diamond and the sets of electrode,
a lower part comprising the triaxial cable,
said upper and lower parts being contiguous, the bottom of the upper part being adjacent to the top of the lower part,
the conductive wires extending from their upper extremities connected to the sets of electrode through the lower part of the support, in particular wherein said single crystal diamond is mounted in the symmetry axis of said support, the length of the single crystal diamond inside the upper part being comprised from about 0.2 mm to about 1.2 mm, in particular wherein said upper part of said support is constituted with a first polymer, in particular with polybenzylmethacrylate (PBzMA), provided that said first polymer is compatible with said connected means and in particular wherein said lower part of said support is constituted of a second polymer, identical or different from the first polymer, in particular selected from the group consisting of materials as close as possible to the tissue equivalence: Polymethylmethacrylat (PMMA), Polybenzylmethacrylate (PBzMA), crosslinked polystyrene, Solid Water (SW), Polydimethylsiloxane (PDMS), virtual water.

13. Diamond dosimeter according to claim 11, wherein said support or said lower part and said upper part of said support present a cylindrical form, in particular the diameter of which is comprised from about 2 mm to about 6 mm, in particular wherein said single crystal diamond is located at about 0.5 mm to about 1.6 mm, in particular at about 0.5 mm to about 1 mm, from the top of the support or of the upper part, and in particular wherein the distance between the bottom of the single crystal diamond and the top of the triaxial cable is comprised from 1 cm to more than 3 cm, in particular between 3 and 4 cm.

14. Diamond dosimeter according to claim 11, comprising further an electrical isolation, in particular with a colloid graphite, a lacquer, a paint, a graphite epoxy resin carbon charged epoxy resin, or carbon conductive paste, all around the cylindrical form of said first and second polymer, and wherein said guard is connected to said first polymer by said isolation wire.

15. (canceled)
